(19) United States
(12) Patent Application Publication
(10) Pub. No.: US 2026/0018850 A1
(43) Pub. Date: Jan. 15, 2026

(54) RARE EARTH ION IMPLANTED PHOTONIC INTEGRATED CIRCUIT LASER

(71) Applicant: ECOLE POLYTECHNIQUE FEDERALE DE LAUSANNE (EPFL), Lausanne (CH)

(72) Inventors: Yang LIU, CHAVANNES-RENENS (CH); Zheru QIU, CRISSIER (CH); Xinru JI, ECUBLENS (CH); Tobias KIPPENBERG, ST-SULPICE (CH)

(21) Appl. No.: 18/652,957

(22) Filed: May 2, 2024

(30) Foreign Application Priority Data
May 5, 2023 (EP) 23171863.6

(51) Int. Cl. H01S 3/063; H01S 3/0941; H01S 3/16

(52) U.S. Cl. CPC H01S 3/0637; H01S 3/0941; H01S 3/1603

(57) ABSTRACT

Hybrid integrated photonic integrated circuit laser comprising a photonic integrated circuit including an elongated optical waveguide comprising an elongated gain medium waveguide, at least a first and second optical reflector, the gain medium waveguide being located or extending between the first and second optical reflectors and being located inside an optical cavity to provide optical feedback. Further comprising a pump laser diode to provide electromagnetic radiation to the gain medium waveguide. The elongated optical waveguide, and the first and second optical reflectors are monolithically integrated inside the photonic integrated circuit. The gain medium waveguide comprises a rare-earth ion implanted silicon nitride waveguide core. The pump laser diode is positioned adjacent to the at least one photonic integrated circuit and is edge coupled or facet coupled to a lateral edge or a facet of the photonic integrated circuit to provide pump radiation to the rare-earth ion implanted silicon nitride waveguide core.

### CROSS-REFERENCE TO RELATED APPLICATIONS

The present patent application claims priority to European Patent Application No. EP23171863.6 that was filed on May 5, 2023, the contents thereof herewith incorporated by reference in its entirety.

### FIELD OF THE INVENTION

The present invention relates to a rare earth ion implanted photonic integrated circuit laser. The present invention more particularly concerns a hybrid integrated rare earth ion implanted photonic integrated circuit laser.

### BACKGROUND

Erbium-doped fiber lasers exhibit high coherence and low noise as required for applications in fiber optic sensing, gyroscopes, LiDAR, and optical frequency metrology.

Erbium-doped fiber lasers (EDFLs) have become indispensable sources of high coherence laser light for distributed acoustic sensing, optical gyroscopes, free-space optical transmission, optical frequency metrology, and high-power laser machining and are considered the ‘gold standard’ of laser phase noise. EDFLs exhibit many advantages such as all-fiberized cavities, alignment-free components, and benefit from the advantageous Erbium-based gain properties including slow gain dynamics, temperature insensitivity, low amplification related noise figure, lower spontaneous emission power coupled to oscillating modes than short semiconductor gain media, and excellent confinement of laser radiation for high beam quality. These properties along with low phase noise have led to wide proliferation of Erbium-based fiber lasers in industrial applications.

Erbium ions can provide equally a basis for compact photonic integrated circuit-based lasers that can benefit from manufacturing at lower cost, smaller form factor and reduced susceptibility to environmental vibrations compared to fiber lasers.

Endowing Erbium-based gain in photonic integrated circuits could provide a basis for miniaturizing low-noise fiber lasers to chip-scale form factor, and enable large-volume applications. Yet, while major progress has been made in the last decade on integrated lasers based on silicon photonics with III-V gain media, the integration of Erbium lasers on chip has been compounded by large laser linewidth.

Prior efforts have been made to implement chip-based waveguide lasers using Erbium-doped materials such as Al₂O₃, TeO₂, LiNbO₃, and Erbium silicate compounds as waveguide claddings or cores, but the demonstrated laser intrinsic linewidth remained at the level of MHz, far above the sub-100-Hz linewidth achieved in commercial fiber lasers and state-of-the-art heterogeneously or hybrid integrated semiconductor-based lasers.

One major obstacle to realizing narrow-linewidth Erbium waveguide lasers is the challenge of integrating long and low-loss active waveguides ranging from centimeters to meters-the lengths routinely deployed in fiber lasers to ensure low phase noise, single-frequency operation, and sufficient round-trip gain.

A goal of the present invention is to provide a solution to these inconveniences, and in particular, to provide a chip-based waveguide laser that overcomes the above-mentioned inconveniences and that assures a narrow linewidth, low-noise, high power chip-based waveguide laser, and that advantageously can be widely tunable and assure single-mode lasing operation.

Another goal is to provide a compact photonic integrated circuit-based lasers that can benefit from manufacturing at lower cost, smaller form factor and reduced susceptibility to environmental vibrations compared to fiber lasers.

### SUMMARY

It is therefore one aspect of the present disclosure to provide a photonic integrated circuit laser or a hybrid integrated photonic integrated circuit laser that addresses the above-mentioned inconveniences and needs.

The photonic integrated circuit laser or a hybrid integrated photonic integrated circuit laser Hybrid integrated photonic integrated circuit laser may comprise at least one photonic integrated circuit including at least one elongated optical waveguide comprising at least one elongated gain medium waveguide, at least a first optical reflector and a second optical reflector, the at least one gain medium waveguide being located or extending between the first and second optical reflectors and being located inside an optical cavity formed between the first and second optical reflectors to provide optical feedback to the at least one gain medium waveguide. The photonic integrated circuit laser or a hybrid integrated photonic integrated circuit laser Hybrid integrated photonic integrated circuit laser may further comprise at least one pump laser diode to provide electromagnetic radiation to the gain medium waveguide to generate lasing operation by the at least one photonic integrated circuit.

The at least one elongated optical waveguide, the first optical reflector and the second optical reflector may be monolithically integrated inside the at least one photonic integrated circuit. The at least one gain medium waveguide may comprise a rare-earth ion implanted silicon nitride waveguide core.

The at least one pump laser diode may be positioned adjacent to the at least one photonic integrated circuit and is edge coupled or facet coupled to a lateral edge or a facet of the at least one photonic integrated circuit to provide pump radiation to the at least one rare-earth ion implanted silicon nitride waveguide core to generate lasing operation by the at least one photonic integrated circuit.

Another aspect of the present disclosure concerns an operating method of the photonic integrated circuit laser or a hybrid integrated photonic integrated circuit laser to operate the laser in single-mode lasing operation and/or optical tuning of the single-mode lasing wavelength.

The Inventors overcome the previously mentioned challenges and demonstrate hybrid integrated rare earth-ion doped waveguide lasers (EDWLs) using Si₃N₄ photonic integrated circuits that achieve narrow linewidth, frequency agility, high power, and the integration with pump lasers. Meter-scale-long Erbium-implanted silicon nitride (Er:Si₃N₄) photonic integrated circuits are used. The Si₃N₄ photonic integrated circuit moreover exhibits an absence of two-photon absorption in telecommunication bands, radiation hardness for space compatibility, high power handling of up to tens of watts, a lower temperature sensitivity than silicon, and low Brillouin scattering (a power-limiting factor in silica-based fiber lasers).

The Inventors demonstrate a fully integrated chip-scale rare earth ion (Erbium) laser that achieves high power, narrow linewidth, frequency agility and the integration of a III-V pump laser. The exemplary laser circuit is based on an Erbium-implanted ultralow-loss silicon nitride (Si₃N₄) photonic integrated circuit. This device achieves single-mode lasing with a free-running intrinsic linewidth of 50 Hz, a relative intensity noise of <−150 dBc/Hz at >10 MHz offset, and an output power up to 17 mW, approaching the performance of fiber lasers and state-of-the-art semiconductor extended cavity lasers.

An intra-cavity microring-based Vernier filter enables wavelength tunability of >40 nm within the C-and L-bands while attaining side mode suppression ratio (SMSR) of >70 dB, surpassing legacy fiber lasers in tuning and SMRS performance.

This new class of low-noise, tunable Erbium waveguide laser can find applications in LiDAR, microwave photonics, optical frequency synthesis, and free-space communications. The approach also extends to the other wavelengths where rare-earth ions provide gain. Doping or co-doping other rare-earth ions such as ytterbium (emission at 1.1 μm), praseodymium (visible, and infrared at 1.3 μm), neodymium (1.064 μm and 1.3 μm), and thulium (0.8 μm, 1.45 μm and 2.0 μm) allows access to other wavelengths.

Moreover, the rare earth ion-doped waveguide laser uses foundry compatible silicon nitride waveguides, and can combine fiber-laser coherence with low size, weight, power and cost of integrated photonics.

This laser can find application not only in existing applications but may equally provide a disruptive solution for emerging applications that require high volumes, such as lasers for coherent FMCW LiDAR, or for coherent optical communications where ITLA (integrated tunable laser assembly) have been widely deployed, but fiber lasers' high coherence is increasingly demanded for advanced high-speed modulation formats while their use has been impeded by the high cost and large size.

The compatibility of silicon nitride with heterogeneously integrated thin-film lithium niobate, as well as piezoelectric thin films, and Erbium waveguide amplifiers provides the capability to create fully-integrated high-speed, low-noise, high-power optical engines for LIDAR, long-haul optical coherent communications, and analog optical links.

The above and other objects, features and advantages of the present invention and the manner of realizing them will become more apparent, and the invention itself will best be understood from a study of the following description with reference to the attached drawings showing some preferred embodiments of the invention.

### BRIEF DESCRIPTION OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1 schematically shows an exemplary embodiment of an exemplary hybrid integrated photonic integrated circuit laser of the present disclosure, implemented as a hybrid integrated Er:Si₃N₄ laser.

FIG. 2A schematically shows another exemplary embodiment of the hybrid integrated photonic integrated circuit laser of the present disclosure, implemented as a hybrid integrated Er:Si₃N₄ laser, and schematically shows a hybrid integrated Vernier laser consisting of an Erbium-implanted silicon nitride Er:Si₃N₄ photonic integrated circuit and an exemplary edge-coupled III-V semiconductor pump laser diode.

FIG. 2B is an optical image of an Er:Si₃N₄ laser circuit integrated with micro heaters for wavelength and phase tuning. The dashed circle indicates the Erbium-implanted gain spiral.

FIG. 2C is an optical image of the Erbium-implanted spiral waveguides indicated by the box in FIG. 2B.

FIG. 2D shows an exemplary coupling regime of the Vernier filter indicated by the box in FIG. 2B.

FIG. 2E shows an exemplary fabrication process flow of an exemplary Er:Si₃N₄ photonic integrated circuit based on selective Erbium ion implantation.

FIG. 3A shows an optical image of an exemplary hybrid integrated Er:Si₃N₄ vernier laser operated in single-mode lasing, the Er:Si₃N₄ Vernier laser being edge-coupled with a pump laser diode chip (for example, 3SP Technologies, 1943 LCv1), green luminescence was observed, stemming from the transition from higher-lying levels of excited Erbium ions to the ground state.

FIG. 3B shows a measured optical spectrum of single-mode lasing. The inset shows the output power as a function of the pump power.

FIG. 3C shows a measured time-frequency spectrogram of a heterodyne beatnote between the packaged EDWL and a fully-stabilized frequency comb (FC 1500, Menlo Systems GmbH) over 4 hours.

FIG. 3D shows an experimental setup for Vernier filter characterization.

FIG. 3E is an Illustration of the Vernier effect by measuring the superposed resonances through the intermediate bus waveguide of the Vernier filter.

FIG. 3F is a zoomed-in range of the measured transmission. Circles indicate the resonances of each micro-ring of the Vernier filter.

FIG. 3G shows a wide-range transmission of the Vernier filter overlaid with the Erbium ion gain spectrum (bottom left).

FIG. 3H shows a frequency spacing variation between adjacent ring resonances of the Vernier filter, yielding a Vernier spacing of 4.65 THz, corresponding to 37.1 nm.

FIG. 31 shows curve fitting of the measured through port transmission of the resonance indicated in FIG. 3F, and the calculated filtering response at the drop port.

FIG. 4A shows an experimental setup for demonstration of wideband tuning of the laser wavelength.

FIG. 4B shows the operating principle of the wavelength tuning of the vernier laser. The traces indicate the transmission of each over-coupled microresonator and the entire vernier filter, respectively.

FIG. 4C shows a two-dimensional laser wavelength tuning map, showing the wavelength of the predominant lasing mode as a function of the electrical power applied to two microheaters. The dashed line schematically indicates the approach to coarse wavelength tuning. The white regions indicate that the expected laser emission was missing due to the micro-ring resonance misalignment or a competing lasing mode when approaching the edge of the WDM filter transmission band.

FIG. 4D shows measured optical spectra of single-mode lasing tuned over a 40 nm wavelength range. The optical spectrum analyzer's resolution bandwidth was set to 0.1 nm.

FIG. 5A shows experimental setups for the measurement of laser frequency noise, relative intensity noise, and intrinsic laser linewidth of a fully hybrid integration of an EDWL.

FIG. 5B is an optical image of a fully hybrid integrated EDWL assembly.

FIG. 5C shows measured laser frequency noise based on heterodyne detection with different reference lasers EDWL1, EDWL2 and EDWL3.

FIG. 5D shows measured and fitted spectra of a delayed self-heterodyne interferometric measurement for intrinsic laser linewidth investigation.

FIG. 5E shows measured laser relative intensity noise (RIN) based on direct photodetection.

FIG. 5F shows relaxation oscillation peaks under varied pump power.

FIG. 6 shows a tunable laser performance comparison. The key performance metrics including intrinsic linewidth, wavelength tuning range, and side mode suppression ratio (SMSR) of state-of-the-art integrated lasers based on Erbium-doped gain media and heterogenous/hybrid III-V semiconductors are summarized, in comparison with Erbium-doped fiber lasers and commercially deployed ITLA (integrated tunable laser assembly). The size of the scatters indicates the achieved SMSR. The required laser intrinsic linewidth of 100 kHz for 400ZR optical transmitters is indicated by the dashed line.

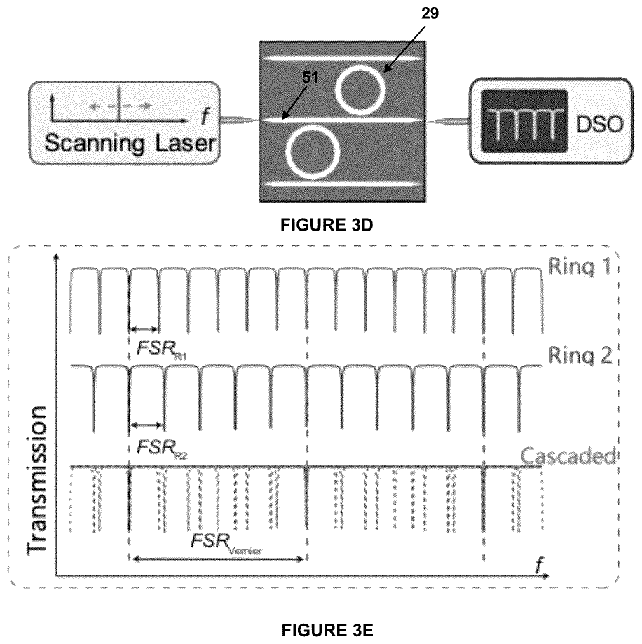

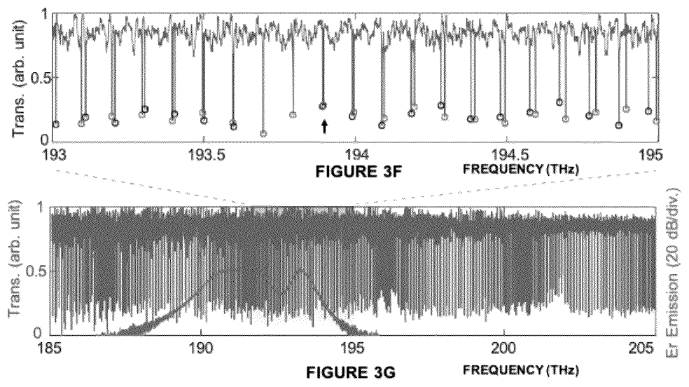

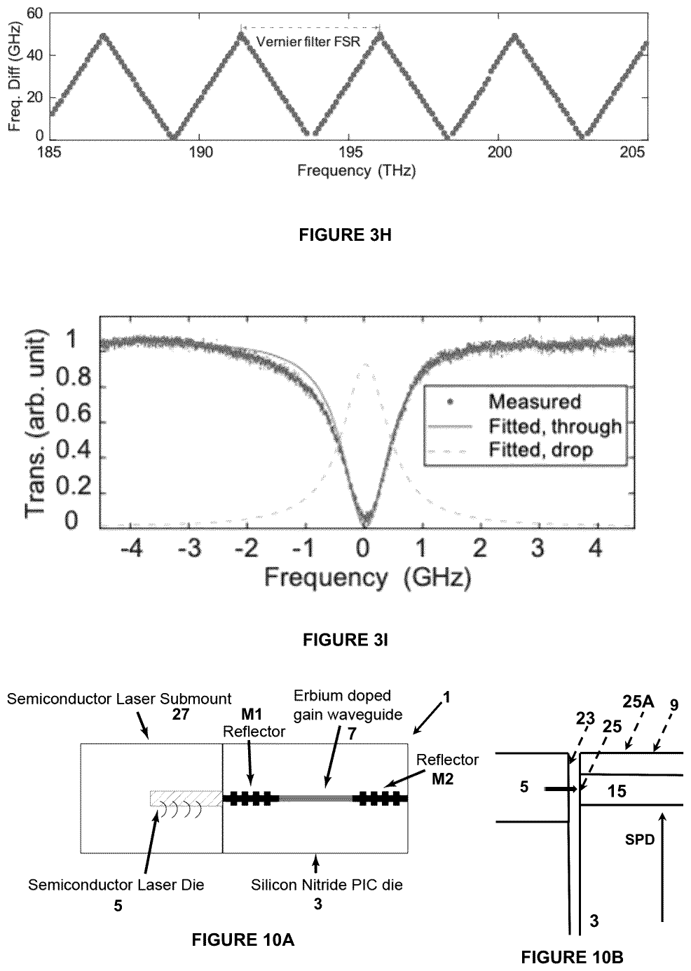

FIG. 7 shows exemplary integrated EDWLs as a graphic design system GDSII layout of the integrated EDWLs, and shows a part of the photonic chip layout that comprises or consists of three EDWLs with different Erbium-doped gain spiral lengths of for example 17 cm, 23 cm, and 31 cm. FIG. 7 illustrates the circuit design layout of a Vernier based laser located in the third device row of FIG. 3A. Each EDWL device exhibits an exemplary compact footprint of only 2×3 mm². The laser device is structured as a linear optical cavity with a spiral Erbium-doped gain waveguide, a microresonator-based Vernier filter, and two partial reflectors formed by exemplary loop mirrors at both ends. The length of the spiral waveguides implanted with Erbium ions was varied from 17 cm to 31 cm for exemplary test purposes. The radii of two micro-ring resonators of the Vernier filter are different and in an exemplary embodiment are for example 228.5 μm and 233.5 μm, respectively, to provide FSRs near 100 GHz but with a 2 GHz difference. The Loop mirror 1 is designed as a Sagnac loop composed of a broadband directional coupler, aiming to provide broadband laser light reflection. Loop mirror 2 is based on a Sagnac loop consisting of a longer, dichroic direction coupler, providing reflection near 1550 nm and transmission near 1480 nm, (pump wavelength). The waveguide directional coupler is for example configured to have a coupling ratio to assure high transmission at the pump wavelength (for example 1480 nm) and a coupling ratio to assure high reflection at a target lasing wavelength (for example, 1550 nm). Therefore, the output port of Loop mirror 2 can be simultaneously used for optical pump injection and laser light extraction (Pump input port 2 or Laser output port 2). The optical pump can also be injected through the port connected to the bus waveguide of the Vernier filter (Pump input port 1).

FIG. 8 schematically shows exemplary fabrication process steps or flow for an exemplary fabrication method of an erbium-doped Si₃N₄ photonic integrated circuit.

FIG. 9 shows a wavelength tuning map and a three-dimensional scatter plot of wavelengths of the dominating lasing mode versus the power applied on two microheaters.

FIG. 10A shows a simplified schematic of a hybrid integrated photonic integrated circuit laser of the present disclosure.

FIG. 10B shows a simplified schematic of an exemplary hybrid coupling or combination integrating a pump laser with a photonic integrated circuit to form the hybrid integrated photonic integrated circuit laser of the present disclosure.

FIG. 11 shows a simplified schematic of a portion of the photonic integrated circuit and an embodiment of a residual pump light removal device of the photonic integrated circuit.

FIG. 12 shows another exemplary embodiment of a hybrid integrated photonic integrated circuit laser of the present disclosure in which the pump light is optically coupled or propagated to a laser optical gain device via an integrated on-chip optical coupler.

FIG. 13 shows another exemplary embodiment of a hybrid integrated photonic integrated circuit laser of the present disclosure in which the pump light is optically coupled or propagated to a plurality of laser optical gain devices via a plurality of integrated on-chip optical couplers.

FIGS. 14 is a schematic representation of an exemplary embodiment an optical coupler of the present disclosure.

FIG. 15 show a measured cross-port spectral response of exemplary couplers of the present disclosure in which transmission measurements reach a maximum near 1480 nm and a minimal near 1550 nm. From the measurement of devices across the entire wafer or chip, the transmission is shown to exhibit good consistency demonstrating the robustness against the waveguide dimension variation.

FIG. 16 is a schematic representation of another exemplary embodiment of an optical coupler of the present disclosure.

FIG. 17 shows another exemplary embodiment of a hybrid integrated photonic integrated circuit laser of the present disclosure in which the pump light is optically coupled or propagated to a plurality of laser optical gain devices via an on-chip integrated pump power splitter.

FIG. 18 is schematic representation of an exemplary on-chip integrated pump power splitter of an embodiment of the present disclosure.

FIG. 19 shows another exemplary embodiment of a grating-based hybrid integrated photonic integrated circuit laser of the present disclosure.

Herein, identical reference numerals are used, where possible, to designate identical elements that are common to the Figures. Also, the images are simplified for illustration purposes and may not be depicted to scale.

### DETAILED DESCRIPTION OF SEVERAL EMBODIMENTS

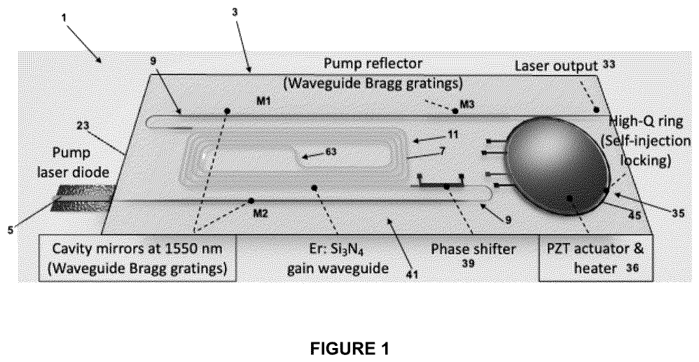

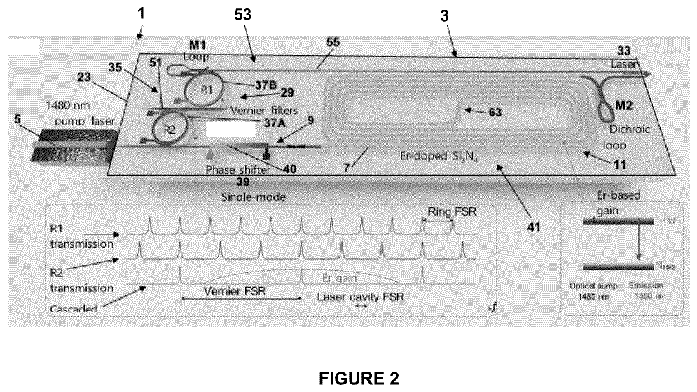

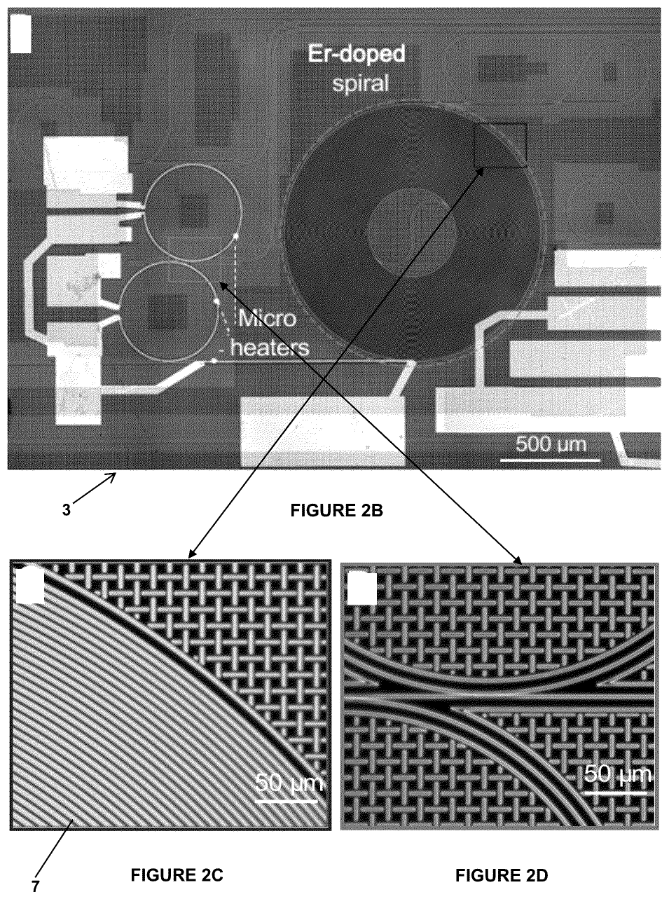

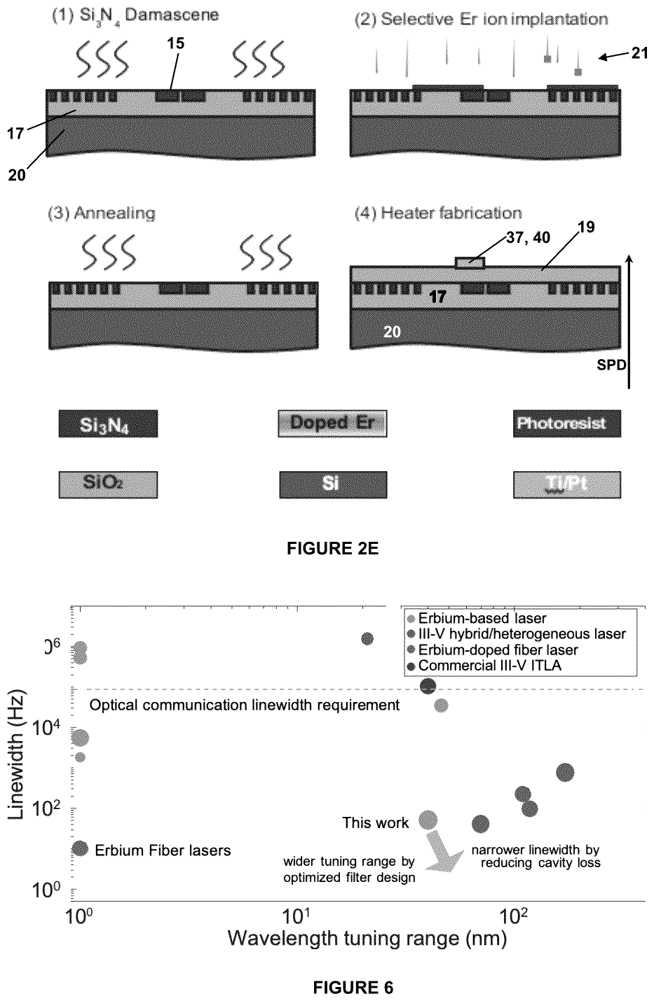

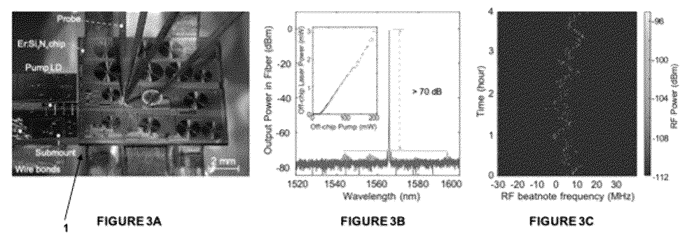

FIGS. 1 and 2A schematically show exemplary embodiments of rare earth ion laser device or system 1 of the present disclosure. FIGS. 1 and 2A schematically show an exemplary embodiment of the photonic integrated circuit laser system 1 or an exemplary embodiment of the hybrid integrated photonic integrated circuit laser 1 of the present disclosure.

Another independent aspect of the present disclosure concerns the at least one photonic integrated circuit 3 described herein, and for which exemplary embodiments are shown in FIG. 1 and FIG. 2A. The photonic integrated circuit 3 may comprises the elements described herein described in relation to the hybrid configuration and the hybrid integrated photonic integrated circuit laser 1 for which exemplary embodiments are shown in FIGS. 1 and 2A. The photonic integrated circuit 3 may additionally include additional elements described herein such as an integrated pump laser.

The hybrid integrated photonic integrated circuit laser 1 or the photonic integrated circuit laser system 1 comprises, for example, at least one photonic integrated circuit 3 and at least one pump laser or pump laser diode 5 to provide electromagnetic radiation to a gain medium waveguide 7 of the photonic integrated circuit 3. The pump laser 5 comprises or consists of, for example, a III-V semiconductor laser diode, for example commercially available from companies such as 3SPTechnologies.

The photonic integrated circuit 3 includes at least one elongated optical waveguide 9 comprising the gain medium waveguide 7, and at least a first optical reflector M1 and a second optical reflector M2.

A section or elongated section of the elongated optical waveguide 9 includes the gain medium waveguide 7. The gain medium waveguide 7 comprises, for example, an elongated silicon nitride (for example Si₃N₄) waveguide core (a gain medium waveguide core). The elongated silicon nitride waveguide core is implanted or doped with rare earth ions. The gain medium waveguide 7 thus includes or is a rare-earth ion implanted silicon nitride waveguide core.

The waveguide core of the elongated optical waveguide 9 and the gain medium waveguide 7 are partially or preferably fully enclosed in a cladding material. The cladding material has a lower refractive index than that of the waveguide core of the elongated optical waveguide 9 and the gain medium waveguide 7 to allow propagation and guiding of electromagnetic radiation or light along the direction of elongation or extension of the elongated waveguide core, the optical waveguide 9 and the gain medium waveguide 7.

While the preferred exemplary embodiment of the present disclosure presents an exemplary elongated optical waveguide 9, a gain medium waveguide 7 and a waveguide core comprising or consisting of silicon nitride, other materials may for example alternatively be included. For example, the elongated optical waveguide 9, the gain medium waveguide 7 and the waveguide core may comprise or consist of Lithium niobate LiNbO₃, Aluminum oxide Al₂O₃, or Tellurium dioxide TeO₂.

The gain medium waveguide 7 is located or extends between the first and second optical reflectors M1, M2 and is located inside an optical cavity 11 formed between the first and second optical reflectors M1, M2 to provide optical feedback to the gain medium waveguide 7 to stimulate emission from the implanted rare earth ions (for example, following optical pumping or excitation of the gain medium waveguide 7) and generate light amplification inside the optical cavity 11 to assure lasing operation.

The first and second optical reflectors M1, M2 are, for example, configured to reflect light at the (targeted) lasing wavelength of the laser system 1 back into the optical cavity 11 formed between the first and second optical reflectors M1, M2. The first or second optical reflector M1, M2 is also configured to transmit or partially transmit light at the lasing wavelength of the laser system 1 to output the lasing light or signal to a laser light output 33 of the laser or system 1. In the exemplary embodiments of FIGS. 1 and 2A, the first reflector M1 is configured to transmit or partially transmit light at the lasing wavelength of the laser system 1 to output the lasing light or signal to the laser light output 33 of the laser or system 1.

In the exemplary embodiment illustrated in FIG. 2A, each of the first reflector M1 and the second reflector M2 comprise or consist of a loop mirror or a waveguide loop mirror that define or form the optical cavity 11. The loop mirror may comprise or consist of, for example, a Sagnac loop mirror or Sagnac loop (see, for example, “Sagnac interference in integrated photonics” by Arianfard et al, Appl. Phys. Rev. 10, 011309 (2023), the contents thereof herewith incorporated by reference in its entirety). Further details of exemplary implementations of a loop mirror or a waveguide loop mirror are provided further below.

In the exemplary embodiment illustrated in FIG. 1, each of the first reflector M1 and the second reflector M2 may comprise or consist of a waveguide Bragg grating that define or form the optical cavity 11. Additional reflectors may also be included in the photonic integrated circuit 3. For example, an additional reflector M3 is optionally included in the exemplary embodiment illustrated in FIG. 1 and configured to reflect light at the pump wavelength of the pump laser diode 5 back into the optical cavity 11 permitting to increase the efficiency of the laser system 1.

While both the first reflector M1 and the second reflector M2 may comprise or consist of the same reflector or mirror type, alternatively, the first reflector M1 and the second reflector M2 may be of different types. For example, the first reflector M1 may be a waveguide Bragg grating and the second reflector M2 may be formed or defined by a Sagnac loop.

The waveguide Bragg grating may, for example, be or comprise a distributed Bragg reflector (DBR) configuration, a distributed feedback (DFB), a phase-shifted DFB, or an apodized DFB configuration (for example, comprise an apodized grating) that assure reflection at the rare earth ion emission wavelength at which lasing is targeted and permit to form the optical cavity 11 assuring optical feedback, and that assure transmission at the pump wavelength to permit excitation of the rare earth ions of the gain medium waveguide 7 (see for example “Advances in Waveguide Bragg Grating Structures, Platforms, and Applications: An Up-to-Date Appraisal” by Butt et al, Biosensors 2022, 12(7), 497, the contents thereof herewith incorporated by reference in its entirety). The waveguide Bragg grating may, for example, comprise a chirped grating, or tapered grating.

The first reflector M1 and/or the second reflector M2 are, for example, configured to transmit electromagnetic radiation emitted at the emission wavelength of the pump laser diode to permit transmission to the gain medium waveguide 7 and the implanted rare earth ions. The first reflector M1 and/or the second reflector M2 are, for example, configured to reflect electromagnetic radiation at the radiation emission wavelength of the implanted rare earth ions to define and form the optical cavity 11 and provide optical feedback of light (spontaneously) emitted by the rare earth atoms or ions to assure that light emission is stimulated by optical feedback of the optical cavity 11 and assure lasing operation.

The first reflector M1 and/or the second reflector M2 is (are) also configured to (partially) transmit light at the radiation emission wavelength of the implanted rare earth ions that undergoes stimulated emission and output lasing light from the optical cavity 11 and/or from the photonic integrated circuit 3. The first reflector M1, for example, in the illustrated embodiments is configured in such a manner to output the laser emission.

The photonic integrated circuit 3 includes a laser light output 33. The laser light output 33 is optically coupled to the first or second reflector M1, M2 through which the laser emission is transmitted to the laser light output 33. The laser light output 33 may, for example, include the elongated optical waveguide 9 that extends continuously or monolithically from the first or second reflector M1, M2 through which the laser emission is transmitted. The laser light output 33 may include for example an output lateral side or facet (for example, extending parallel to the material or layer superposition direction SPD) or an output upper or top facet (for example, extending (substantially) perpendicular to the material or layer superposition direction SPD) through which the laser emission exits the photonic integrated circuit 3. The laser light output 33 may alternatively optically couple to an integrated optical device (not illustrated) included on the photonic integrated circuit 3

The elongated optical waveguide 9 extends across the photonic integrated circuit 3. In an embodiment, the elongated optical waveguide 9 (and the gain medium waveguide 7) includes the exemplary elongated silicon nitride (Si₃N₄) waveguide core or core material 15, a first or lower cladding layer or material 17 and a second or upper cladding layer or material 19 located, for example, opposite the first or lower cladding layer or material 17, the silicon nitride Si₃N₄ waveguide core or material 15 being located between the lower and upper cladding materials or layers, 17, 19 (see, for example, FIG. 2E). The lower and upper cladding materials or layers, 17, 19 comprise or consist of, for example, silicon oxide SiO₂.

The elongated optical waveguide 9, the first optical reflector M1 and the second optical reflector M2 are, for example, monolithically integrated inside the photonic integrated circuit 3. The elongated optical waveguide 9, the gain medium waveguide 7, the first optical reflector M1 and the second optical reflector M2 are, for example, are contained or included inside a common planar support layer of the photonic integrated circuit 3. The support layer is, for example, the first or lower cladding layer or material 17.

The first optical reflector M1 and the second optical reflector M2 also, for example, each include the elongated silicon nitride waveguide core or material 15. The first optical reflector M1 and the second optical reflector M2 may also each include the first or lower cladding layer or material 17 and the second or upper cladding layer or material 19.

The elongated optical waveguide 9 or the elongated silicon nitride waveguide core thereof is, for example, directly optically coupled to, or optically evanescently coupled to or in optical communication with the first and/or second reflectors M1, M2 or the elongated (silicon nitride) waveguide core of the first and second reflectors M1, M2. This is, for example, the case of the first reflector M1 in the illustrated embodiment of FIG. 2A, where the first reflector M1 is optically coupled to the elongated optical waveguide 9 via an intermediate element 29.

Alternatively, the elongated optical waveguide 9 and the elongated silicon nitride waveguide core extend to define the first and/or second reflectors M1, M2 and continuously extend through the first and/or second reflectors M1, M2. This permits a continuous light communication or propagation through the same silicon nitride waveguide core material and reduced optical loss stemming from transition loss or back reflection loss. This is, for example, the case of the second reflector M2 in the illustrated embodiment of FIG. 2A, where the second reflector M2 is defined by the elongated optical waveguide 9 and the elongated silicon nitride waveguide core extending to delimit a loop mirror structure. This is, for example, also the case of the reflectors M1, M2, M3 in the illustrated embodiment of FIG. 1, where a waveguide Bragg gratings are implemented or formed in the elongated optical waveguide 9.

The first optical reflector M1 and/or the second optical reflector M2 may, for example, thus comprise the elongated silicon nitride waveguide core continuously extending through the first optical reflector M1, through the elongated optical waveguide 9 and through the second mirror M2, and extends between the first optical reflector M1 and the elongated optical waveguide 9, and between the elongated optical waveguide 9 and the second mirror M2.

The first or lower cladding layer or material 17 is, for example, superposed (provided directly or indirectly) on at least one substrate or planar substrate 20 (see for example FIG. 2E). The second or upper cladding layer or material 19 is, for example, superposed (provided directly or indirectly) on the first or lower cladding layer or material 17 (and on the on at least one substrate or planar substrate 20). The silicon nitride (Si₃N₄) waveguide core or material 15 is, for example, directly provided and contained in recesses or depressions formed inside the first or lower cladding layer or material 17.

The photonic integrated circuit 3 thus may comprise for example the substrate 20, enclosing cladding layer or material, for example, the first or lower cladding layer or material 17, and the second or upper cladding layer or material 19, and also comprise the elongated silicon nitride waveguide core or material 15.

The gain medium waveguide 7 comprises the elongated silicon nitride waveguide core implanted or doped with rare earth ions (a gain medium waveguide core) and enclosing cladding layer or material, for example, the upper and lower cladding layers or materials 17, 19.

The implanted rare-earth ions 21 (see for example FIG. 2E), for example, consist of Erbium, Ytterbium, or Thulium. The implanted rare-earth ions 21 may, for example, comprise one or more of: Erbium, Ytterbium, Thulium. The silicon nitride waveguide core or material 15 may, for example, be co-doped or co-implanted with a plurality of ions. The implanted rare-earth ions 21 may, for example, comprise Erbium and Ytterbium, or Erbium and Thulium, or Erbium, Ytterbium and Thulium ions.

The implanted rare-earth ions 21, for example, consist of Erbium, or Ytterbium, or Thulium or praseodymium or neodymium. The implanted rare-earth ions 21 may, for example, comprise one or more of: Erbium, Ytterbium, Thulium, praseodymium, neodymium.

The implanted rare-earth ion concentration may, for example, be between 0.1×10²⁰ cm⁻³ and 3.5×10²⁰ cm⁻³.

The gain medium waveguide 7 forms a lasing medium or optical gain device of the laser or system 1. The gain medium waveguide 7 has, for example, a length between 10 cm and 100 cm that extends across the photonic integrated circuit 3. The gain medium waveguide 7 may, for example, extend to define a spiral or loop structure.

The elongated optical waveguide 9, the first optical reflector M1 and the second optical reflector M2 extend coplanar across the photonic integrated circuit 3. The elongated optical waveguide 9, the first optical reflector M1 and the second optical reflector M2 lie, for example, in the same light propagation plane.

The light propagation plane extends parallel to a substrate plane of the substrate 20 supporting the photonic integrated circuit 3 or upon which the photonic integrated circuit 3 is superposed. The light propagation plane extends perpendicular to a material or layer superposition direction SPD (see for example FIG. 2E) on the substrate 20 supporting the photonic integrated circuit 3. The light propagation plane extends perpendicular to the first or lower cladding layer or material 17 superposition direction (for example, substantially vertical) on the substrate 20 and/or the second or upper cladding layer or material 19 superposition direction (for example, substantially vertical) on the substrate 20.

The elongated optical waveguide 9, the first optical reflector M1 and the second optical reflector M2 are, for example, contained in the same host material layer, or located in/at the same planar level in the photonic integrated circuit 3.

The elongated optical waveguide 9, the gain medium waveguide 7 and the rare earth ion implanted or doped silicon nitride waveguide core are buried inside the photonic integrated circuit 3.

The pump laser diode 5 is configured to generate electromagnetic radiation at a wavelength that is absorbed by the gain medium waveguide 7 and the implanted rare earth ions 21 to produce excited states whose light emission can be stimulated by optical feedback by the optical cavity 11 of light (spontaneously) emitted by the rare earth atoms or ions upon absorption of the electromagnetic radiation energy provided by the pump laser diode 5.

In one embodiment, the pump laser or pump laser diode 5 comprises or consists of a laser configured to simultaneously emit a plurality of pump wavelengths at spectrally separated/distinguishable pump wavelengths. The pump laser is configured to simultaneously emit a plurality of pump wavelengths and to simultaneously pump the laser optical gain device simultaneously with plurality of spectrally separated/distinguishable pump wavelengths. The pump laser 5 comprises or consist of, for example, a multi-longitudinal mode laser that is configured to simultaneously emit a multiple wavelengths. The multiple wavelength pumping allows to avoid or reduce unwanted absorption of the pump light in the filter 29, for example, in the Vernier rings or resonators R1, R2 that lowers the energy efficiency of the system or laser 1. The plurality of pump wavelengths may, for example, be at wavelengths of x, y and z and thus the pump energy is spread over a range of wavelengths that optically pump the gain medium 7 and that have a reduced absorption or optical loss in components or elements outside the gain medium 7.

Preferably, the pump laser diode 5 comprises or consist of, for example, a semiconductor laser diode or at least one semiconductor laser diode, or a III-V semiconductor laser diode or at least one III-V semiconductor laser diode.

A plurality of pump laser diodes 5 may, for example, be included on a semiconductor chip or device (for example, a III-V semiconductor chip or device) which is coupled to the photonic integrated circuit 3 (the exemplary Si₃N₄ chip 3) to each separately pump a plurality of laser optical gain devices 41 on the photonic integrated circuit 3 (for example one laser optical gain devices 41 of the plurality thereof). Alternatively, a multiple channel pump laser diode may be coupled to the Si₃N₄ chip 3 and each channel separately pumps a plurality of laser optical gain devices 41 on the photonic integrated circuit 3 (for example one laser optical gain devices 41 of the plurality thereof).

The laser optical gain device 41 includes, for example, the elongated optical waveguide 9, the first and second optical reflectors M1, M2 and the gain medium waveguide 7 of the photonic integrated circuit 3.

Alternatively, the semiconductor chip or device may include one pump laser diode whose output is then split to each separately pump a plurality of laser optical gain devices 41 on the photonic integrated circuit 3. A light splitter may, for example, be included on the semiconductor chip or device comprising the pump lasers, and located between the pump laser and the photonic integrated circuit 3.

In an embodiment, the light splitter is an integrated pump light splitter 133 contained or included on the photonic integrated circuit 3 (see, for example, FIG. 17). The integrated pump light splitter 133 is configured to split pump light p and distribute the split pump light to separately pump at least one or a plurality of laser optical gain devices 41 on the photonic integrated circuit 3.

The integrated Vernier laser of this embodiment also provides a scalable implementation of a laser array on the chip, using on-chip pump splitting (see, for example, FIG. 17). This approach is both scalable, and can be extended to integrated laser numbers to be more than 2, depending on the specific applications

The at least one on-chip integrated pump power splitter 133 (see, for example, FIG. 18) includes at least one or a plurality of light splitters 135 configured to divide or split pump light p, provided or coupled to an input port 25, 25A (see, for example, FIGS. 10A and 10B), into a plurality of waveguide cores WC5₁ . . . WC5₄ that each propagate the pump light to or towards laser optical gain devices 41 on the photonic integrated circuit 3, or waveguide cores of elongated waveguides 9 or gain mediums 7 into which the pump light is coupled, for example, by butt coupling or evanescent coupling.

The exemplary embodiment shown in FIG. 18 includes an on-chip integrated pump power splitter 133 comprising two light splitters 135 configured to divide or split pump light p, provided or coupled to an input port 25, to two waveguide cores WC5₂, WC5₂, each one forming part of an optical coupler (such as that described herein further below) to optically couple the pump light to the elongated waveguide 9.

The or each of the waveguide cores WC5₁ . . . WC5₄ includes, for example, an output port 147 through which split pump light p passes and is propagated/coupled to a waveguide core of an elongated waveguide 9. The output port 147 is, for example, located internally inside the photonic integrated circuit 3. Each output port 147 may, for example, be in light communication with at least one input light pump port of an elongated waveguide 9 of a laser optical gain device 41. The input light pump port 25 and the output port 147 may, for example, be located internally inside the photonic integrated circuit 3. For example, the waveguide core of the elongated waveguide 9 may be seamlessly or continually connected to the waveguide core WC5.

Each of the plurality of waveguide cores WC5₁ . . . WC5₄ may continue, for example, to extend across the photonic integrated circuit 3.

The input port 25, 25A is configured to receive input pump light p. The input port 25, 25A may comprise for example an interface, face or facet, or may be a location where light or pump light is received or propagated/guided through. The input port 25, 25A may, for example, be located internally inside the photonic integrated circuit 3, or may be located at an outer or external surface of the photonic integrated circuit 3.

The light splitter 35 may, for example, comprise a directional coupler, a multi-mode interferometer, or a Y splitter each of which is configured to split inputted pump light into at least two split pump light signals/beams. The splitting is, for example, preferably a 50:50 splitting (substantially).

The photonic integrated circuit 3 may thus include the input port 25, 25A that is coupled to one (sole) optical pump (laser) source or pump laser which provides input pump light p thereto and that is then split-up into multiple pump light beams (four in the exemplary case of the splitter 133 of FIG. 18) to supply four exemplary devices 41 or gain mediums 7 with split pump light via, for example, directly by a continued and seamless connection or extension to the elongated waveguide or gain medium 7, or alternatively via an optical coupler or WDM coupler, for example, the optical coupler 65 described herein further below.

The on-chip integrated pump power splitter 133 may be formed in the same manner as the elongated waveguide 9 and comprise the same materials. The waveguide core of the on-chip integrated pump power splitter 133 may include or be formed by the waveguide core of the elongated waveguide 9.

The on-chip integrated pump power splitter 133 is configured to receive the optical pump light p, for example, from a (single) laser diode (see, for example, FIG. 17) at the input port, and to split the received optical pump light into a plurality of optical pump light beams, and distribute the split optical pump light and/or optical pump light beams to each of the device 41 or gain mediums 7.

A single pump laser diode's output can be split into multiple waveguides via an on-chip power splitter 133, each of which can individually pump the gain waveguide 7 of the integrated rare earth ion implanted waveguide.

The on-chip pump power splitter 133 advantageously provides an on-chip integrated pump power splitting and routing of the pump light. A high pump power laser diode, which is single-channel and of wide-cross-section (multi-mode), can advantageously be injection locked to a fundamental mode of the waveguide. Moreover, the coupling alignment is less-complex due to the use of this coupling between one waveguide and one pump channel. This contrasts with the currently known approach of using a high-power pump laser diode remotely pumping the chip through an optical fiber to avoid heating the chips by the pump laser diode itself which generates instability in the chip and the operation thereof.

The pump laser diode 5 can be edge coupled or facet coupled to a lateral edge or lateral facet 25 of the photonic integrated circuit 3 (see, for example, FIGS. 10A and 10B) to provide pump electromagnetic radiation to the elongated optical waveguide 9 and/or the rare-earth ion implanted silicon nitride waveguide core.

The pump laser diode 5 is positioned adjacent to or side-by-side with the photonic integrated circuit 3. The pump laser diode 5 is positioned (adjacent to or side-by-side) to couple pump light or electromagnetic radiation emitted by the pump laser 5 into photonic integrated circuit 3. The pump laser diode 5 may directly or indirectly contact the photonic integrated circuit 3. A light emitting face or facet 23 of the pump laser diode 5 is positioned opposite or facing a lateral side or lateral facet 23 of the photonic integrated circuit 3.

The lateral side or lateral facet 23 extends parallel to the material or layer superposition direction SPD. The light emitting face or facet 23 of the pump laser diode 5 is, for example, positioned opposite or facing a lateral side or lateral facet of an elongated silicon nitride waveguide core or material of an optical waveguide in optical communication with the optical cavity 11, for example, the elongated (silicon nitride) waveguide core or material 15 of the elongated optical waveguide 9 (as in the illustrated examples of FIGS. 1 and 2A).

The pump laser diode 5 may, for example, be supported by or held on a mount 27. The laser 5 and/or mount 27 are, for example, held in a fixed position relative to the photonic integrated circuit 3.

The pump laser diode 5 is, for example, optically edge coupled or facet coupled to a lateral edge or lateral facet 25 of the elongated optical waveguide 9 to provide light to edge coupled or facet 25 and insertion into the photonic integrated circuit 3 and the gain medium waveguide 7.

Pump light insertion may transit via, for example, the first reflector M1 or the second reflector M2 to the optical cavity 11.

Alternatively, the pump laser diode 5 is edge coupled or facet coupled to a lateral edge or lateral facet 25 of an injection waveguide of the photonic integrated circuit 3. The injection waveguide, may for example, be tapered and optically connected to or in optical communication with a (ring) bus waveguide of the photonic integrated circuit 3, the (ring) bus waveguide being in optical communication (for example, via evanescent coupling) with the elongated optical waveguide 9 to permit pump radiation injection into the elongated optical waveguide 9 and the gain medium waveguide 7. The injection waveguide and the (ring) bus waveguide may be formed, for example, in the same manner as the elongated optical waveguide 9 and comprise a silicon nitride waveguide core and upper and lower (SiO₂) cladding layers or materials.

The pump laser diode 5 can alternatively be coupled to a top/upper facet or surface 25A of the photonic integrated circuit 3 to provide pump electromagnetic radiation to the photonic integrated circuit 3, and/or to the elongated optical waveguide 9 and/or to the silicon nitride waveguide core and/or to the rare-earth ion implanted silicon nitride waveguide core.

The pump laser diode 5 is positioned adjacent to a top/upper surface 25A of the photonic integrated circuit 3, or positioned on the top/upper surface 25A of the photonic integrated circuit 3 to couple or evanescently couple pump electromagnetic radiation to the photonic integrated circuit 3, and/or the elongated optical waveguide 9 and/or the silicon nitride waveguide core. The pump laser diode 5 may, for example, be positioned on and in contact with the photonic integrated circuit 3 by heterogeneous integration or heterogeneous attachment. The pump laser diode 5 is, for example, heterogeneously integrated with the photonic integrated circuit 3.

The top/upper facet or surface 25A extends in a planar manner across the photonic integrated circuit 3. The top or upper facet or surface 25A extends (substantially) perpendicular to the material or layer superposition direction SPD. An outer layer or material of the photonic integrated circuit 3 comprises, for example, the top/upper facet or surface 25A.

The laser or system 1 is, for example, a fully packaged rare earth-doped laser via hybrid integration of a (Si₃N₄) photonic integrated circuit 3 and a semiconductor power laser diode 5.

The photonic integrated circuit 3 may include, for example, at least one optical device or optical filtering device 35 configured to determine or set a single-mode lasing operation and/or a single-mode lasing wavelength of the hybrid integrated photonic integrated circuit laser 1 and/or tune a single-mode lasing wavelength of the photonic integrated circuit 3 or the hybrid integrated photonic integrated circuit laser 1.

The photonic integrated circuit 3 may include, for example, at least one lasing wavelength tuner or a plurality of lasing wavelength tuners (or tuning means) 36, 37A, 37B, 40 configured to determine and tune a lasing wavelength of the photonic integrated circuit 3 or the hybrid integrated photonic integrated circuit laser 1.

The optical device 35 may, for example, include a ring resonator, for example, a (high-Q) ring resonator 45 (formed with the same materials and in the same manner as the elongated optical waveguide 9), optically coupled (evanescently coupled) to the elongated waveguide 9 (see for example FIG. 1) and configured to assure self-injection locking between the optical cavity 11 and the resonator 45 to set a single-mode lasing wavelength of the hybrid integrated photonic integrated circuit laser (see for example “Recent advances in laser self-injection locking to high-Q microresonators”, Front. Phys. 18, 21305 (2023), by Kondratiev et al, the contents thereof herewith incorporated by reference in its entirety). The optical device 35 may, for example, also include a (micro) heater and/or a piezoelectric actuator 36 arranged or configured to act on the ring resonator 45 (as, for example, shown in the illustrated embodiment of FIG. 1) to tune or adjust the single-mode lasing wavelength.

The heater or microheater 36 is located adjacent to resonator 45 to transfer heat energy to the material of the resonator 45 to change and/or tune the refractive index value of the material of the resonator 45 permitting to tune the resonant wavelength of the resonator 45.

The piezoelectric actuator includes, for example, a piezoelectric material comprising or consisting of aluminium nitride (AlN) and/or lead zirconate titanate (PZT). The piezoelectric actuator includes for example a first or bottom electrode, a piezoelectric material superposed on the bottom electrode, and a top or second electrode superposed on the piezoelectric material. The electrodes are configured to apply an electric field across the piezoelectric material when a DC voltage difference is applied to the first and second electrodes which expands or contracts the piezoelectric material and deforms the waveguide core of the ring resonator 45 which is located in proximity and/or below the piezoelectric material. This for example permits to change the resonator optical path length, for example, the optical path length or radius of the ring resonator 45 and to change, tune and/or set the resonant wavelength of the ring resonator 45.

The piezoelectric actuator is located or formed, for example, above the ring resonator 45, for example, on the cladding material. The piezoelectric actuator is, for example, located directly above the waveguide core material (for example silicon nitride) of the ring resonator 45. The piezoelectric actuator may for example at least partially extend along the direction of extension of the ring resonator 45 to interact with the properties of the waveguide core material. The piezoelectric actuator may comprise, for example, an aluminium nitride (AIN) layer (for example, 1 micron in thickness), a molybdenum bottom electrode (for example, 100 nm in thickness), and an aluminium top electrode (for example, 100 nm in thickness).

The optical device or optical filtering device 35 may alternatively or additionally include an intra-cavity optical filter 29 located between the first and second mirror M1, M2, as for example, shown in the illustrated example of FIG. 2A. The intra-cavity optical filter 29 is in optical communication with the elongated optical waveguide 9 and the first mirror M1.

The intra-cavity optical filter 29 comprises or consists of, for example, a Vernier filter including a first resonator R1 and a second resonator R2. The first and second resonators R1, R2 are optically coupled for, example, evanescently coupled to each other. The first resonator R1 is optically coupled (evanescently coupled) to the first mirror M1 and the second resonator R2 is optically coupled (evanescently coupled) to the elongated optical waveguide 9. The first resonator R1 and the second resonator R2 are arranged to form cascaded add-drop resonators to define a Vernier free spectral range FSR (see for example Vanessa Zamora et al, “Investigation of cascaded SiN microring resonators at 1.3 μm and 1.5 μm,” Opt. Express 21, 27550-27557 (2013), the contents thereof herewith incorporated by reference in its entirety). This permits wavelength filtering to select a wavelength at which single-mode lasing operation can be achieved.

The intra-cavity optical or vernier filter 29, for example, drops light at the wavelength where the two resonators have an overlapping resonances to provide the (dropped) light at that wavelength to the reflector M1, which is reflected back into the optical cavity 11 via the intra-cavity optical or vernier filter 29.

The diameters or radii of two micro-ring resonators R1, R2 of the Vernier filter are preferably different in value. The first and second resonators R1, R2 are, for example, optically coupled by an intermediate elongated waveguide core 51 extending between the resonators and for, example, evanescently optically coupled to each of the resonators R1, R2. The intermediate waveguide core 51 is for example preferably fabricated in the same manner as the elongated optical waveguide 9 and from the same material type.

The intra-cavity optical filter 29 is configured to provide a transmission signal at a wavelength aligned with a longitudinal mode wavelength of the optical cavity 11, and within an erbium ion emission wavelength range. This permits to select a lasing longitudinal mode and single-mode lasing operation, as assure a narrow laser linewidth. The intra-cavity optical filter 29 is further configured to remove erbium ion spontaneous emission at wavelengths outside the lasing longitudinal mode wavelength. This can be done, for example, by the value of the radius that is set or defined for each of the first and second resonators R1, R2 and/or the waveguide core material used to form the first and second resonators R1, R2. The intra-cavity optical filter 29 filters or selects the light wavelength that is accumulated and reflected between the first and second reflectors M1, M2 and that results in single-mode lasing operation at the filtered wavelength.

The intra-cavity optical filter 29 may further include intra-cavity optical filter tuners 37A, 37B configured to change a wavelength of the transmission signal provided by the intra-cavity optical filter 29. The intra-cavity optical filter tuner 37A, 37B may, for example, comprise or consist of a heater/microheater and/or a piezoelectric actuator. The intra-cavity optical filter tuner 37A, 37B is configured to act on the first resonator R1 and/or the second resonator R2 to change a resonance wavelength of the first resonator R1 and/or the second resonator R2 to overlap the resonance wavelengths and determine a lasing wavelength of the laser 1. For example, one or more heaters (for example, heater 37A in thermally coupled to the second resonator R2 and heater 37B thermally coupled to first resonator R1) are located to be in thermal communication with the resonators R1, R2. Further details of the intra-cavity optical filter 29 and the operation thereof are provided below, in particular in relation with FIGS. 3A to 31, and FIGS. 4A to 4D. The heater/microheater and the piezoelectric actuator are, for example, identical or formed in the same manner as those of the ring resonator 45 of the embodiment of FIG. 1. The integrated piezoelectric actuators advantageously allow a fast linear tuning, and the microheaters advantageously allow slower and larger range thermal tuning. FIG. 12 shows a further exemplary embodiment of the photonic integrated circuit laser 1 in which the photonic integrated circuit 3 and the intra-cavity optical filter includes both heater/microheaters and piezoelectric actuator for each of the first resonator and the second resonator.

The photonic integrated circuit 3 may, for example, further include at least one phase shifter 39 located between the first and second mirrors M1, M2 and arranged to act on the elongated optical waveguide 9 to displace a cavity longitudinal mode of the optical cavity 11. This permits fine tuning to a lasing wavelength to be carried out. The phase shifter 39 may, for example, comprise at least one heater 40 (or alternatively, a piezoelectric actuator) located to be in thermal communication with the elongated optical waveguide 9 to provide heat thereto to shift a cavity longitudinal mode of the optical cavity 11 and, for example, align with the transmission wavelength of the intra-cavity optical filter 29 and/or to the passband of the intra-cavity optical filter 29, thus determining the wavelength of the lasing operation. The heater/microheater and the piezoelectric actuator are, for example, identical or formed in the same manner as those of the ring resonator 45 of the embodiment of FIG. 1.

The intra-cavity optical filter 29 and the phase shifter 39 including the tuning elements such a heaters or piezoelectric actuators permit a wide wavelength tuning of the laser 1.

A single-mode frequency-agile or tunable integrated rare earth ion-doped laser 1 is thus provided.

The elongated optical waveguide 9, the first and second optical reflectors M1, M2 and optionally the further elements described above define a laser optical gain device 41 on the photonic integrated circuit 3 that is configured to assure lasing operation when pumped by a pumping laser diode 5. The photonic integrated circuit 3 may include a plurality of such laser optical gain devices (as for example shown in FIG. 3A and FIG. 7) and the hybrid integrated photonic integrated circuit laser 1 may include such a photonic integrated circuit 3 and one or a plurality of pumping laser diodes 5 associated or attached with the photonic integrated circuit 3, as previously described.

In another embodiment, the photonic integrated circuit 3 includes a residual pump light removal device 53. The residual pump light removal device 53 is configured to reduce or eliminate residual pump light from the laser output light or signal that is outputted by the photonic integrated circuit 3, and/or the laser or system 1, via for example output 33.

In one embodiment, the residual pump light removal device 53 includes the additional reflector M3 (see for example FIG. 1) that is configured to reflect light at the pump wavelength of the pump laser diode 5 back into the optical cavity 11 and to transmit light at the lasing wavelength to provide the lasing light for output.

In another embodiment, the residual pump light removal device 53 includes an elongated waveguide 55 connected and optically coupled to the vernier filter 29, to the drop port or elongated waveguide 57 that extends to and connects the reflector M1 with the first resonator R1 (see for example FIG. 11). The elongated waveguide 55 extends from the first resonator R1 and from the drop port or elongated waveguide 57 to the laser output 33. The elongated waveguide 55 is, for example, fabricated in the same manner as the elongated waveguide 9 and may comprise the same materials. These two ring resonators form a Vernier filter with passbands that are very narrow, discrete, and largely spectrally sparse, so that it can block most of or even all of the pump laser spectrum components.

The drop port of the Vernier micro-ring-based filter 29, that is used for the laser output, can improve the laser side-mode suppression ratio (SMSR) and reduce the relative intensity noise due to the rejection of the broadband amplified spontaneous emission (ASE) noise.

In an embodiment, the photonic integrated circuit 3 includes at least one mode stripper device 63 (see for example FIGS. 1 and 2A). The gain medium waveguide 7 includes or contains the mode stripper device 63. The mode stripper device 63 is configured to remove transversal optical modes from the elongated waveguide 9 allow a single or sole transversal mode to propagate in the elongated waveguide 9. The mode stripper device 63 includes, for example, an elongated waveguide of narrower or reduced width (in a direction perpendicular to the SPD direction) compared to that of the gain medium waveguide 7. The mode stripper device 63 includes, for example, a curved elongated waveguide, for example, extending to define a S-bend.

The mode stripper device 63 is, for example, integral with the gain medium waveguide 7 and continuously extends as part of the extension of the gain medium waveguide 7 in or on the photonic integrated circuit 3 and is for example made of the same material.

As mentioned previously, the gain medium waveguide 7 extends to define a spiral or loop structure. The spiral or loop structure includes, for example, the mode stripper device 63. The center of the S bend of the spiral waveguide structure uses, for example, a reduced waveguide width to introduce higher radiative loss for the high order optical modes, to function as a mode stripper, to ensure single transversal mode operation and to assure or facilitate single longitudinal mode lasing.

In an embodiment, the photonic integrated circuit 3 includes at least one or a plurality of optical couplers 65. The optical coupler 65 is configured to receive pump light from at least one pump laser or pump laser diode 5 and to propagate the pump light across the photonic integrated circuit 3 and optically couple the pump light into an element of the laser optical gain device 41, for example, the elongated waveguide 9. This provides an additional or alternative manner to provide pump light to the gain medium waveguide 7. The exemplary embodiment of FIG. 12 shows one pump laser 5 providing pump light to an optical waveguide and waveguide core of the optical coupler. Pump light coupling is carried out to a lateral edge or lateral facet of the optical coupler 65 that is or comprises, for example, the lateral edge or lateral facet 25 of the photonic integrated circuit 3, as previously described. The exemplary embodiment of FIG. 13 shows a first pump laser 5 providing pump light to an optical waveguide and waveguide core of a first optical coupler optically coupled to an elongated waveguide 9 of a first laser optical gain device 41, and a second pump laser 5 providing pump light to an optical waveguide and waveguide core of a second optical coupler optically coupled to an elongated waveguide 9 of a second laser optical gain device 41.

The integrated Vernier laser of this embodiment provides a scalable implementation of a laser array on the chip, using multi-channel pumping (see, for example, FIG. 13). This approach is both scalable, and can be extended to integrated laser numbers to be more than 2, depending on the specific applications

The optical coupler 65 is, for example, an on-chip wavelength division multiplexing WDM coupler for a pump wavelength of 1480 nm and a lasing signal of 1550 nm, or a pump wavelength of 880 nm and a lasing signal of 1550 nm. These exemplary couplers are particularly useful for a laser optical gain device 41 having the exemplary Er doped silicon nitride gain medium waveguide 7.

The coupler is configured to insert light at the pump wavelength into the laser optical gain device 41 while simultaneously allowing the target lasing wavelength or the lasing wavelength or signal to pass through the coupler and be reflected between the first and second resonators M1, M2.

The (for example, 980 nm/1550 nm) WDM coupler 65 or (for example, 1480 nm/1550 nm) WDM coupler 65 may, in one embodiment, comprise a (substantially) straight directional coupler (two closely spaced (substantially) parallel waveguides evanescently coupled), as schematically indicated in FIG. 12.

In one exemplary embodiment, at least one coupling or coupler section or elongated coupling or coupler section 125 of an embedded planar waveguide core WC5 of an on-chip integrated optical pump waveguide device extends in proximity or adjacent to at least one coupling or coupler section or elongated coupling or coupler section 127 of the embedded planar waveguide core of the elongated waveguide 9 to allow evanescent light coupling between the embedded planar waveguide core WC5 and the elongated waveguide 9 This evanescently couples pump light p into the elongated waveguide 9 and the laser optical gain device 41.

The coupler section 125 of the embedded planar waveguide core WC5 of the on-chip integrated one optical pump waveguide device may, for example, be a continuous and integral part of the embedded planar waveguide core WC5; or may for example be an individual waveguide section that is optically connected or in optical communication with the embedded planar waveguide core WC5, or that assures continued optical communication and light propagation along and through the embedded planar waveguide core WC5. This is similarly the case for the coupler section 127.

The elongated section 125 includes, for example, a (substantially) straight elongated portion and the elongated section 127 includes a (substantially) straight elongated portion. The straight elongated portion of the elongated section 125 is separated by a gap or distance from the straight elongated portion of the elongated section 127 that assures evanescent light coupling between the waveguides. The straight elongated portion of the elongated section 125, for example, extends (substantially) parallel to the straight elongated portion of the elongated section 127 and/or (substantially) at the same height as that of straight elongated portion of the elongated section 127 from a surface of the supporting substrate or layer 20 to assures evanescent light coupling of the pump light therebetween.

In this exemplary embodiment, the integrated on-chip coupler 65 includes the coupling or coupler section or elongated coupling or coupler section 125 of the embedded planar waveguide core WC5 of the on-chip integrated one optical pump waveguide device, and the coupling or coupler section or elongated coupling or coupler section 127 of the embedded planar waveguide core of the elongated waveguide 9. The integrated on-chip coupler 65 is, for example, a directional coupler. The elements of the optical coupler may for example be fabricated in the same manner as the elongated waveguide 9 and comprise the same materials.

An alternative embodiment of a (for example 1480 nm/1550 nm) WDM coupler 65 (for example for a 1480 nm pump/1550 nm lasing signal) with improved robustness against dimension variations and fabrication imperfection is based on an interferometer structure, as schematically shown in FIG. 14.

The on-chip integrated coupler 65 or on-chip integrated wavelength-division multiplexer 65 is, for example, configured to combine the optical pump light p (for example at or about 1480 nm) and the lasing light signal s (for example at or about 1500 nm) to provide them to the laser optical gain device 41 and the gain medium waveguide 7.

The straight directional coupler of the previously described embodiment is sensitive to dimension variation of the waveguide sections 125, 127 and the distance between them that can be caused by an imperfect fabrication. The WDM coupler 65 of the present embodiment (see for example FIG. 14) can assure robustness against such dimension variation and/or a compact footprint.

The WDM coupler 65 includes, for example, the at least one coupling or coupler section or elongated coupling or coupler section 125 of the embedded planar waveguide core WC5 of the on-chip integrated one optical pump waveguide device, and the at least one coupling or coupler section or elongated coupling or coupler section 127 of the embedded planar waveguide core WC of the elongated waveguide 9.

The WDM coupler 65 includes, for example, at least a portion 125 of the embedded planar waveguide core WC5 and includes at least a portion 127 of the embedded planar waveguide core WC of the elongated waveguide 9.

The WDM coupler 65 includes a first directional coupler 171 and a second directional coupler 173, the first and second directional couplers 171, 173 are interconnected by unbalanced waveguide arms 175 (see, for example, FIG. 14).

The WDM coupler 65 includes a first port 177 and a second port 179.

Light may enter the WDM coupler 65 via, for example, the first port 177 and exit via the second port 179, and the optical pump light p and the laser light signal s are combined into the embedded planar waveguide core WC of the elongated waveguide 9, or the optical pump light p transferred into the embedded planar waveguide core WC of the elongated waveguide 9 that is, for example, propagating the lasing light signal s.

Light can also enter the WDM coupler 65 via the second port 179 and exit via the first port 177 to separate optical pump light p and the input light signal s from the embedded planar waveguide core WC (in which both are simultaneously propagating) to transfer the pump light p from the embedded planar waveguide core WC of the elongated waveguide 9 to the embedded planar waveguide core WC5 of the on-chip integrated one optical pump waveguide device, and transfer the lasing light signal s into the embedded planar waveguide core WC of the elongated waveguide 9, resulting in the optical pump light p propagating in the embedded planar waveguide core WC5, and the lasing light signal s propagating in the embedded planar waveguide core WC of the elongated waveguide 9 and towards the first resonator M1.

The coupler section 125 and/or the coupler section 127 extend, for example, between the first port 177 and the second port 179.

The first port 177 includes a coupler section port 125A and a coupler section port 127A. The second port 179 includes a coupler section port 125B and a coupler section port 127B.

Optical pump light p (for example, at about 1480 nm) is for example provided/coupled to the coupler section 125 (for example, at or through coupler section port 125A) and the lasing light signal s (for example, at about 1500 nm) is for example provided/propagated to or into the coupler section 127 at the first port 179 (for example, at or through coupler section port 127A) for combination by the coupler 65.

Input light signal s is, for example, provided to the coupler section 127 by the first resonator mirror M1 and the intra-cavity filter 29. Optical pump light p is provided to the coupler section 125 via the input light pump port 25.

The coupler section 125 of the embedded planar waveguide core WC5 and the coupler section 127 of the embedded planar waveguide core WC of the elongated waveguide 9 extend from the first port 177 to the first directional coupler 171. The first directional coupler 171 is configured to split or divide the pump light p and the lasing light signal s into first and second split light portions and provide the first split light portion to a first arm 175A of the unbalanced waveguide arms 175, and provide the second split light portion to a second arm 175B of the unbalanced waveguide arms 175.

In the first directional coupler 171, the coupler section 125 and the coupler section 127 extend, for example, side-by-side and are configured to evanescently couple pump light p from the coupler section 125 to the coupler section 127 and/or the lasing light signal s from the coupler section 127 to the coupler section 125. A portion (for example, preferably about (±5%) 50%) of the pump light p and/or the lasing light signal s is, for example, evanescently coupled between the coupler section 125 and coupler section 127.

In the first directional coupler 171 (and/or the second directional coupler 173), the elongated coupler section 125 includes, for example, a (substantially) straight elongated portion and the elongated coupler section 27 includes a (substantially) straight elongated portion. The straight elongated portion of the elongated section 125 is separated by a gap or distance from the straight elongated portion of the elongated section 127 that assures evanescent light coupling between the waveguides. The straight elongated portion of the elongated section 125, for example, extends (substantially) parallel to the straight elongated portion of the elongated section 127 and/or (substantially) at the same height as that of straight elongated portion of the elongated section 127 from a surface of the supporting substrate or layer 20 to assure evanescent light coupling therebetween.

The coupler section 125 of the embedded planar waveguide core WC5 and the coupler section 127 of the embedded planar waveguide core WC extend away from each other to define the first arm 175A and the second arm 175B of the unbalanced waveguide arms 175. The first arm 175A includes or is defined, for example, by (a section of) the coupler section 127, and the second arm 175B includes or is defined by, for example, (a section of) the coupler section 125. The waveguide arms 175 are unbalanced waveguide arms with the first and second arms 175A, 175B having different elongated waveguide core lengths to, for example, introduce a phase shift and a phase difference between the light propagating through the first arm 175A and the second arm 175B, and through the coupler section 125 and the coupler section 127.

The first and second arms 175A, 175B extend to the second directional coupler 173 and the light propagated thereto, via the first and second arms 175A, 175B, is combined and optical light interference occurs due to the introduced phase shift difference.

In the second directional coupler 173, the coupler section 125 and the coupler section 127 for example extend side-by-side and are configured to evanescently couple the pump light p and/or the lasing signal light s between the coupler section 125 and the coupler section 127 to assure optical interference between the recombined lasing signal or light s and the recombined pump light p to transfer the propagated pump light p from the coupler section 125 to the coupler section 127 (by evanescent coupling and/or optical interference). As a result, the pump light p and lasing light signal s both propagate in the coupler section 127 (to, for example, the second port 179. The pump light p propagates no further in the coupler section 125 or has a significantly reduced intensity in the coupler section 125 in a propagation direction towards the second port 179.

The combined pump light p and lasing light signal s propagate, for example, in the coupler section 127 (for example, to or through coupler section port 127B) and onwards in the embedded waveguide core WC and the rare earth ion implanted planar waveguide core WC in which the rare earth ion implanted waveguide core WC is optically pumped by the pump light p and the lasing light signal s is propagated between the first and second resonators M1, M2.

The coupler section 125 of the embedded planar waveguide core WC5 and the coupler section 127 of the embedded planar waveguide core WC extend away from each other from the second directional coupler 173 (for example, to or through coupler section ports 127A, 127B).

The coupler section 127, for example, extends (continually) onwards as the elongated waveguide 9 and to the gain waveguide medium 7. The coupler section 125 may extend, for example, to terminate inside the photonic integrated circuit 3.

This embodiment is particularly advantageous when the pump light p and input light signal s are close in wavelength, for example, when the pump light p is (about (±10 nm)) 1480 nm and the input light signal s is (about ±20 nm) 1550 nm, for example for Er-implanted waveguide cores.

The WDM coupler 65 can thus, for example, be composed of two directional couplers 171, 173 and the unbalanced waveguide arms 175 located therebetween. The first-stage directional coupler 171 (for example, of elongated waveguide core length of 48 μm) is configured to split the pump p and the signal s into two split light portions with a splitting ratio, for example, preferably near 50%, before entering the unbalanced waveguide arms 175. The light travels in the two waveguides of the arms 175A, 175B that have different lengths, and experience different phase shifts. This phase shift difference leads to light interference when the light passes through the second-stage directional coupler 173. The second-stage directional coupler 173, for example, can have an elongated waveguide core length of 48 μm, and can be configured to couple (for example, preferably about (±5%) 50%) the pump light p and the signal light s between the coupler section 127 and the coupler section 125 and the second-stage directional coupler 173). This waveguide cores of the coupler, may for example, have a cross-sectional thickness of 200 nm, and a 5 μm width.

Since light of different wavelengths, such as 1550 nm and 1480 nm have slightly different propagation constants (corresponding to different effective refractive indices), they will experience different degrees of interference, i.e., constructive, or destructive interference at the same port. The waveguide arm length difference is configured or set (for example, 9 μm) to obtain a phase shift difference that assures the necessary light interference conditions, and as a result, that the majority of the signal light s (near for example 1550 nm) exits from the (north) waveguide port 127B, and the majority of the pump light p (near for example 1480 nm) exits from this same port 127B. In this way, the pump p (near 1480 nm) and the signal s (near 1550 nm) are combined in the same elongated waveguide core 127.

In a reverse manner, the pump p and the signal s entering from the same port 127B can be separated to the two separate ports 127A, 125A. This forms, for example, a decoupler or demultiplexer device. Light is propagated through the decoupler or demultiplexer device in a reverse manner to that of the above-described coupler 65 to separate the pump p and the signal light s, and/or to separate the pump p and the lasing light s.

Compared to the WDM couplers using parallel waveguides, this Mach-Zehnder-interferometer-type WDM coupler can significantly reduce the device length; it is also more resilient against the geometry variation, as the shorter couplers only exhibit less than one period of light coupling and the phase difference is defined by the photolithography precision.

The inventors experimentally demonstrate that this type of WDM coupler can achieve the light combination or separation (for example, at 1480 nm/1550 nm wavelengths), as shown in the measured cross-port spectral response (see, for example, FIG. 15) where transmission measurements reach a maximum near 1480 nm and a minimal near 1550 nm. From the measurement of devices across the entire wafer or chip, the transmission is shown to exhibit good consistency demonstrating the robustness against the waveguide dimension variation.

In another embodiment of the WDM coupler 65, as for example, schematically shown in FIG. 16, and which is particularly advantageous when the pump light p and input light signal s have a relatively larger wavelength separation, for example, when the pump light p is (about (±10 nm)) 980 nm and the input light signal s is (about ±20 nm) 1550 nm, for example, for Er-implanted waveguide amplifiers.

The WDM coupler 65 includes, for example, a single directional coupler 181, or at least one directional waveguide coupler 181.

The directional waveguide coupler 181 may include the elongated coupler section 125 of the embedded planar waveguide core WC5 of the on-chip integrated optical pump waveguide device and the elongated coupler section 127 of the embedded planar waveguide core WC of the elongated waveguide 9.

The elongated coupler section 125 extends, for example, in proximity or adjacent to the elongated coupler section 127 so as to allow evanescent light coupling of pump light p between the at least one integrated one on-chip optical pump waveguide device and the at least one or each on-chip elongated waveguide 9, and/or between the embedded planar waveguide cores.

FIG. 16 shows the WDM coupler 65 for, for example, a 980 nm pump and 1550 nm lasing signal. Due to the relatively large difference in wavelengths and the effective refractive indices at this wavelength difference, a simpler and, for example, shorter directional coupler structure 181 can provide the desirable function. Since the coupler length is short, the 1550 nm light can be coupled to the cross port within one coupling period, while the 980 nm (mainly) stays in the same waveguide arm due to its relatively much weaker evanescent coupling.

Another embodiment concerns shows another grating-based hybrid integrated photonic integrated circuit laser 1, an exemplary schematic representation is shown in FIG. 19. This embodiment concerns, for example, a grating-based Er laser integrated on-chip. The photonic integrated circuit 3 includes an on-chip Bragg grating 67, centered for reflection by the grating at the pump wavelength (for example at or near 1480 nm) to provide feedback to the pump laser III-V chip 5 which permits to stabilize the pump wavelength emission value of the pump laser 5 against temperature variation. The other elements of the hybrid integrated photonic integrated circuit laser 1 are, for example, the same as those described previously in relation to the hybrid integrated photonic integrated circuit laser 1 of FIG. 1, or any one of the other embodiments previously described such as that represented in FIG. 2A.

The pump laser 5 comprises or consists of, for example, a distributed feedback laser (DFB) pump laser diode. In this case, the DFB laser diode is locked to the grating wavelength, via self-injection locking. The pump laser 5 alternatively comprises or consists of, for example, a gain chip such a reflective semiconductor optical amplifier (RSOA). In the ROSA case, the RSOA and the grating 67 are arranged relative to each other to form a laser cavity for the pump light permitting to produce stable lasing wavelength operation.

This grating-based stabilization assures an improved temperature stability, compared to the conventional III-V pump laser diodes that use temperature-sensitive (with a thermo-optic coefficient more than one order of magnitude higher than silicon nitride) III-V material-based grating to determine the lasing wavelength. This grating-based stabilization can be also used with the Vernier laser-based embodiments, as well as the case of other pump wavelength laser sources such as a 980 nm pump.

Further details of the embodiment illustrated in FIG. 2A are now presented in which the gain medium waveguide 7 and the elongated silicon nitride waveguide core or material 15 are doped or implanted with Erbium ions.

As seen in FIG. 2A, the laser device 1 is structured as a linear optical cavity 11 with a spiral Erbium-doped gain waveguide 7 and two reflectors M1, M2 formed by Sagnac loop mirrors at both ends. One dichroic loop mirror M2 comprising or comprised of a dichroic directional coupler allowing or configured for laser reflection near a target lasing wavelength or near 1550 nm (for reflection back into the optical cavity 11) and optical pump transmission near or about 1480 nm, or alternatively near or about 980 nm (for example to transmit or remove optical pump light to and from the optical cavity 11), and the other reflector M1 deploys a loop mirror comprising a short waveguide splitter for broadband reflection. The optical pump can also or alternatively be injected via a waveguide taper connected to a micro-ring bus waveguide. The micro-ring bus waveguide being, for example, in optical communication or optical coupled (for example evanescently) to the elongated waveguide 9. The laser device (FIG. 2B) exhibits a compact footprint of only 2×3 mm² with a densely-packed 0.2 m long Erbium-doped Si₃N₄ spiral waveguide (FIG. 2C) with a cross section of 0.7×2.1 μm².

A narrow-band intra-cavity Vernier filter 29 designed to achieve sub-GHz 3 dB bandwidth and 5 THz free spectral range (FSR) using two cascaded add-drop micro-ring resonators (100 GHz FSRs with 2 GHz difference) (FIG. 2D) is deployed to ensure single-mode lasing operation with a small laser cavity mode spacing of ca. 200 MHz.

Integrated microheaters 37 are used to align the Vernier filter peak transmission wavelength to a cavity longitudinal mode of the optical cavity 11. This integrated laser circuit was fabricated using the photonic Damascene process (see for example, M. H. P. Pfeiffer, A. Kordts, V. Brasch, M. Zervas, M. Geiselmann, J. D. Jost, and T. J. Kippenberg, Optica 3, 20 (2016), publisher: Optica Publishing Group, the entire contents of which are fully incorporated herein by reference), followed by selective Erbium ion implantation, post annealing, and heater fabrication (see for example FIGS. 2E and 8).

This ultralow loss Si₃N₄ photonic integrated laser circuit 3 can be fabricated using the above mentioned photonic Damascene process. The Inventors applied selective Erbium ion implantation (a total fluence of 1×10¹⁶ ions cm⁻² at a maximum beam energy of 2 MeV) to the pre-fabricated passive Si₃N₄ photonic integrated circuits 3 to endow the spiral waveguide 9 with Erbium-based optical gain, while other passive components remain undoped by selectively masking a portion of the chip 3 with photoresist.

A high doping concentration of 3.25×10²⁰ ions cm⁻³ is obtained, more than one order of magnitude higher than that of conventional Erbium-doped fibers. This allows for high roundtrip net gain of 1.9 dB/cm (characterized from a 4.5-mm-long Erbium-doped waveguide) as described in “A photonic integrated circuit-based erbium-doped amplifier”, Y. Liu, Z. Qiu, X. Ji, A. Lukashchuk, J. He, J. Riemens-berger, M. Hafermann, R. N. Wang, J. Liu, C. Ronning, and T. J. Kippenberg, Science 376, 1309 (2022), the entire contents of which are herein fully incorporated by reference. After ion implantation, the sample/chip 3 is annealed at 1000° C. for one hour to activate the Erbium ions and heal implantation defects.

The optical gain is provided by the stimulated emission of erbium ions excited by optical pump electromagnetic radiation, for example at 1480 nm (FIG. 2A inset). Micro-heaters are, for example, subsequently added atop the silica upper cladding after the ion implantation and post annealing processes.

An exemplary fabrication process of the exemplary erbium-doped Si₃N₄ photonic integrated circuit 3 is schematically shown in more detail in FIG. 8. The erbium-doped Si₃N₄ (Er:Si₃N₄) photonic integrated circuit (PIC) 3 is fabricated by the photonic Damascene process, detailed in M. H. Pfeiffer, J. Liu, A. S. Raja, T. Morais, B. Ghadiani, and T. J. Kippenberg, Optica 5, 884 (2018); and J. Liu, G. Huang, R. N. Wang, J. He, A. S. Raja, T. Liu, N. J. Engelsen, and T. J. Kippenberg, Nature communications 12, 1 (2021); the entire contents of both of which are fully incorporated herein by reference.

In an exemplary fabrication, the inventors coated 4-inch wet oxidized silicon wafers 20 with 500 nm amorphous silicon, by low-pressure chemical vapor deposition (LPCVD), as a hardmask HM (FIG. 8, step 1). Structures are defined in the layer 17 (the upper cladding material or layer 17 may, for example, have a thickness of between 1000 nm and 5000 nm, for example, 2000 nm., such structures including recesses for the optical elements of the PIC 3 previously described such as the recesses WR for the waveguide 9, recesses for defining the reflectors M1, M2 and intra-cavity devices, assisting structures ST for stress management, which are defined by standard deep ultra-violet lithography (ASML PAS 5500/350C stepper) and two steps of fluorine chemistry reactive ion etching (RIE) for the hardmask and the waveguide preform in the oxide (Step 2).

After etching, the amorphous silicon hardmask is stripped in heated KOH solution. Annealing of the etched waveguide preform is carried out for reflow (step 3) and stoichiometric Si₃N₄ is deposited to fill the preform (Step 4). A RIE etch-back process and chemical mechanical polishing (CMP) are then applied to planarize and remove excess Si₃N₄ from the top surface of the wafer 20 (Step 5). Planarized wafers are annealed and go through the die separation process.

After the fabrication of the passive Si₃N₄ PIC 3, standard ultra-violet (UV) direct write lithography is used to define an ion implantation mask IM (step 7) (Heidelberg MLA 150, 3 μm AZ 15nXT) which screens or blocks the elements of the PIC 3 that are not to be doped or implanted with rare earth-ions. Then, mounting of the masked dies on a 2-inch carrier wafer for irradiation is carried out.

It is noted that although 3 μm of photoresist is sufficient in stopping all the erbium ions, the ion bombardment and heat produced in the implantation process can significantly modify the photoresist layer, making the resist insoluble in common photoresist removers (AZ P1316 and Technistrip NI 555) and seldomly delaminating from the surface. In later experiments, we increased the resist thickness from 3 μm to 5 μm and significantly improved the yield.

The ion implantation and post-processing process are described in Y. Liu, Z. Qiu, X. Ji, A. Lukashchuk, J. He, J. Riemensberger, M. Hafermann, R. N. Wang, J. Liu, C. Ronning, and T. J. Kippenberg, Science 376, 1309 (2022), the entire contents of which are fully incorporated herein by reference. The erbium ion energy of 0.955 MeV, 1.416 MeV and 2 MeV and the exemplary dose of 2.34×10¹⁵, 3.17×10¹⁵ and 4.5×10¹⁵, respectively (step 8).

The photoresist mask IM after implantation is removed by oxygen plasma and washing in heated HCl solution. The PIC 3 is then annealed at 1000° C. to heal the implantation defects. To avoid potential contamination to the shared LPCVD furnace stack by Er ions, other technologies for the provision of the cladding layer or material 19 of the erbium implanted PIC 3 were used. Radio frequency magnetron sputtered SiO₂ was used as an option for depositing anneal-free low-loss cladding. 2.85 μm of SiO₂ was sputtered on the PIC 3 (Pfeiffer SPIDER 600, 3.5 hours, 3 sccm flow of O₂ and 15 sccm of Ar, 1 KW main RF power and 20 W bias power, process pressure approximately 9.5 mbar) as the cladding layer 19 (step 10).

The upper cladding material or layer 19 may, for example, have a thickness of between 1 nm and 500 nm, for example, 200 nm. Such deposition may alternatively be carried out prior to the ion implantation step, for example, after the nitride annealing step.

Comparing the resonance linewidth measured on ring resonators R1, R2 before and after cladding 19 deposition, the additional optical loss caused by the sputtered oxide cladding 19 was estimated to be 1 to 4 dB/m. It is noted that alternative techniques such as high-density plasma enhanced chemical vapor deposition may be alternatively used, which can deposit SiO₂ layers with significantly lower optical loss, thus further improving the device performance.

Different materials for the fabrication of metallic (micro) heaters were investigated. After extensive testing of device reliability and considering fabrication process complexity, platinum Pt is preferably chosen among Al, Cr, Ti, TiN, Au and Pt for its high melting point, immunity to oxidation, compatibility with shared cleanroom equipment and superior resistance to electromigration degradation.

It was also noticed that increasing the cross-sectional area of the heater trace can also significantly improve the reliability and maximum operating temperature, which is believed to be due to the lower current density needed to generate the same heating power and thus reduced electromigration effect.

In this example, a titanium Ti adhesion layer was used on the SiO₂ cladding for the current carrying Pt layer. To simplify the fabrication process, a passivation layer is not used to cover the Pt layer, which does not significantly impact reliability. Approximately 25 nm of Ti is first sputtered and then 500 nm of Pt (Pfeiffer SPIDER 600) on the cladded PIC (step 11). Then, UV direct write lithography (Heidelberg MLA 150, 3 μm AZ 15 nXT resist) and Ar ion beam etching (Veeco Nexus IBE350, 30° substrate tilt) are applied to define the traces and pads (step 12).

With this optimized process, straight heaters of approximately 600 μm length and 3.5 μm width can reliably operate at power as high as 1 W for at least few hours, reaching 700° C. in the Pt conductor. The resistance of heater on 100 GHz resonators is about 60 Ω and varied for around 9% for different driving power.

A width W of the waveguide core 15 is, for example, between 1.5 and 5 times greater than a height H of the waveguide core 15. For example, the waveguide core 15 may have a width (measured at maximum value) of 2.1 μm and a height H or thickness of 0.7 μm. However, in other embodiments, waveguide core 15 may have a smaller thickness, for example, 200 nm.

Like the elongated optical waveguide 9, an exemplary (substantially) rectangular cross-sectional profile was also used for the loop mirrors M1, M2. However, it is not necessary to use a rectangular cross-sectional profile and other cross-sectional profiles can be used depending on the specific coupling or optical properties that are targeted. The loop mirrors M1, M2 of the exemplary embodiment of FIG. 2A have (substantially) the same Si₃N₄ waveguide core thickness as the elongated optical waveguide 9 but a relatively smaller width of (about) 1.5 μm to assure stronger optical evanescent field coupling. The waveguide core width of the mirrors M1, M2 is not limited to this value and can, however, have other values depending on the specific coupling or optical properties that are targeted.

Characterization measurements were performed on the fabricated PIC 3 operating as the laser of the present disclosure.

To demonstrate a fully integrated erbium-doped waveguide laser EDWL, the inventors performed photonic packaging via hybrid integration in a custom 14-pin butterfly package. An exemplary 1480 nm InP Fabry-Pérot (FP) laser diode (LD) was edge coupled to one of the laser cavities 11 on an Er:Si₃N₄ photonic integrated circuit 3 (FIG. 3A), with simulated coupling loss of <3 dB. The laser output waveguide 33 was end-coupled and glued with a cleaved UHNA-7 optical fiber spliced to a SMF-28 optical fiber pigtail, exhibiting 2.7 dB coupling loss at 1550 nm. The pump LD 5, a Peltier element, a thermistor, and all microheaters are connected to butterfly pins using wire bonding. The integrated micro-heaters 37, 40 were used for the temperature control of the Vernier filter 29 and the phase-shifter section 39 to configure single-mode lasing and wavelength tuning.

The Erbium ions can be optically excited by the pump light emitted from the multi-longitudinal-mode pump LD 5 (>4 nm spectral linewidth near 1480 nm), providing 1.9 dB/cm of measured net gain coefficient. The optical spectrum of the collected laser output shows a single-mode lasing operation with >70 dB of side mode suppression ratio (SMSR) at 0.1 nm resolution bandwidth (FIG. 3B). This high 72-dB SMSR was made possible using the drop port of the narrow passband intra-cavity Vernier filter 29, which can select the lasing mode and reject the broadband amplified spontaneous emission noise. This record high SMSR surpasses what has been reported in integrated Erbium lasers, fiber lasers, and integrated semiconductor-based lasers, typically below 60 dB that is usually limited by intra-cavity filtering performance.

Conversely, this is challenging to implement in legacy fiber-based Erbium lasers where the filtering components based on long Bragg gratings can only offer several GHz wide passband with grating side lobes and lack of broadband wavelength tuning capability. The Inventors observed an off-chip lasing threshold pump power of ca. 20 mW and an on-chip slope efficiency of 6.7% when sweeping the pump power (FIG. 3B inset), which can be further optimized by reducing the coupling loss and the cavity loss. The fully packaged laser showed a frequency drift of <20 MHz over 4 hours (FIG. 3C) when performing a heterodyne beatnote measurement with a fully-stabilized optical frequency comb indicating a good frequency stability due the monolithic nature of the laser comprised of both cavity and gain medium.

During a 24-hour test, this laser showed a frequency drift of <140 MHz without mode hops, representing a comparable long-term frequency stability as a commercial diode laser.

The use of photonic integrated circuits and Vernier structures (FIG. 3) enables to endow the integrated Erbium laser with broad wavelength tuning, a capability that bulk fiber lasers lack.

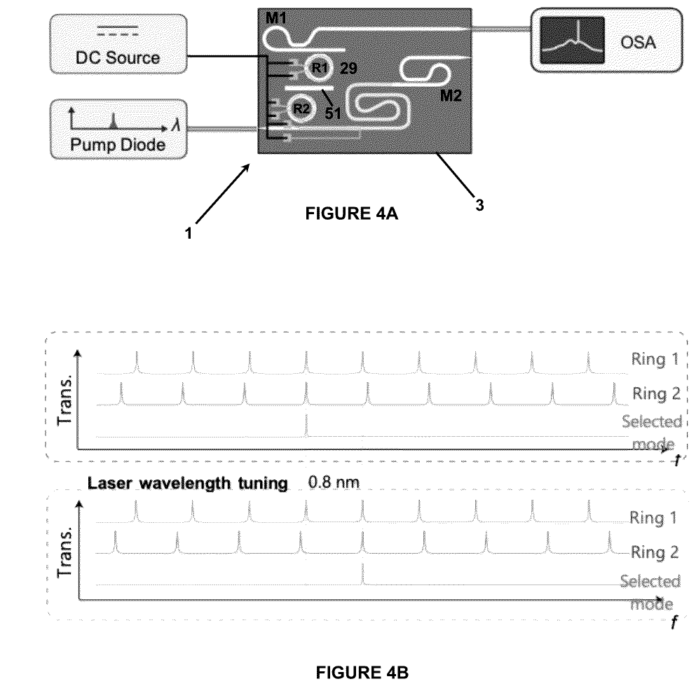

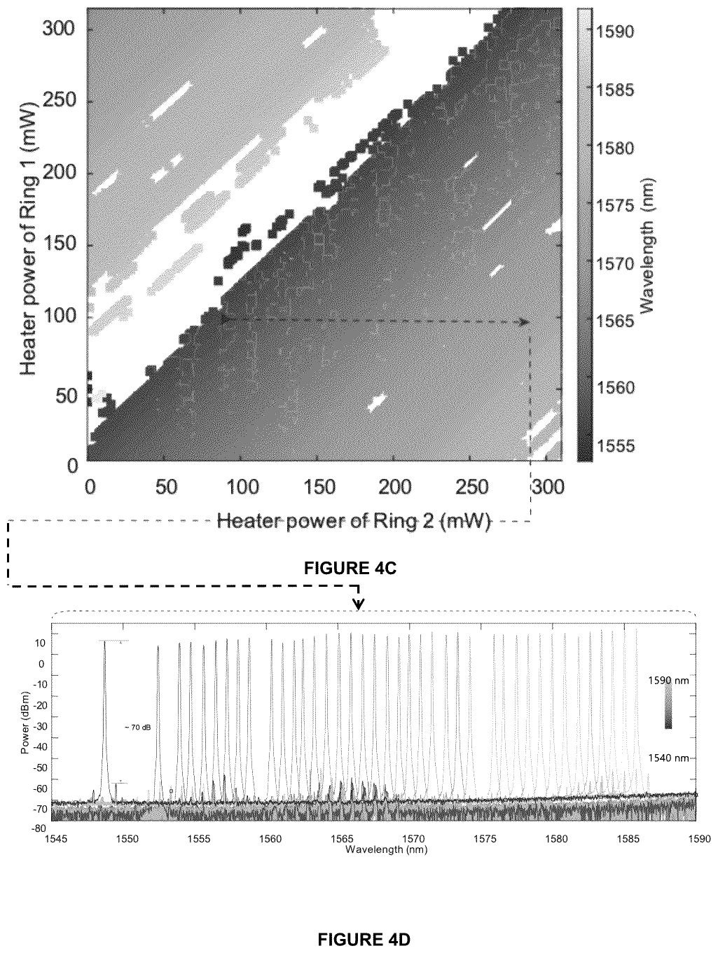

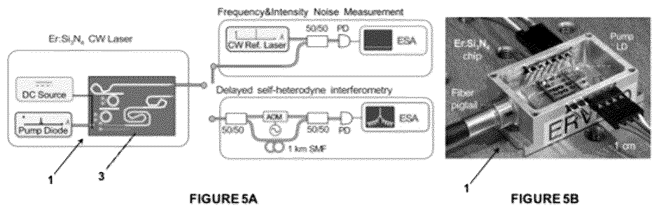

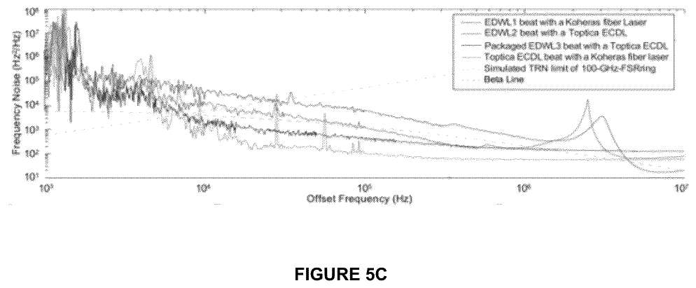

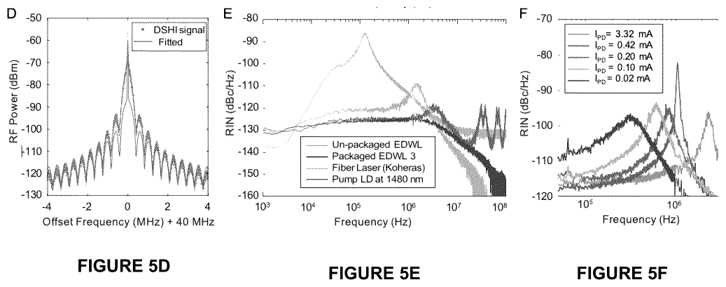

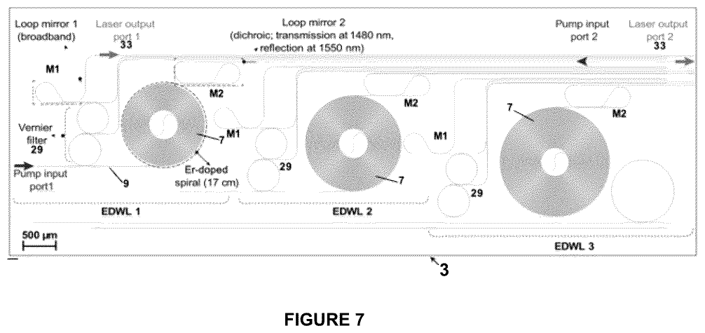

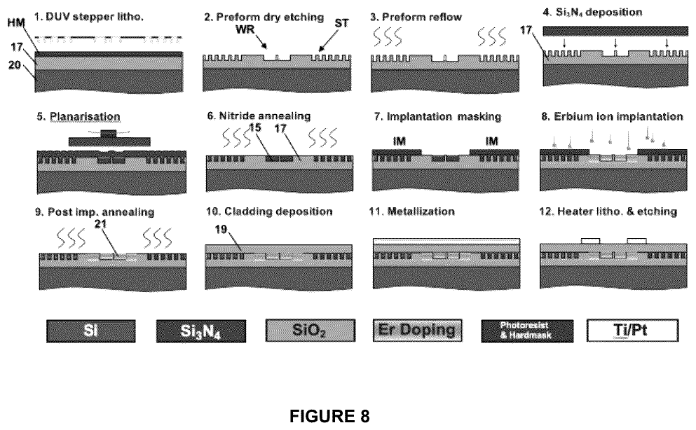

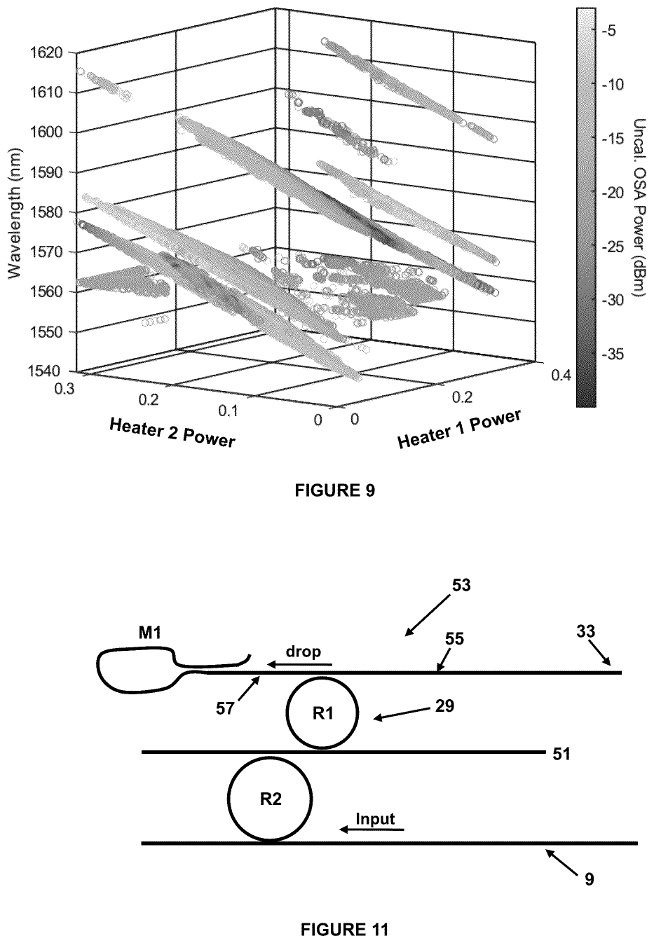

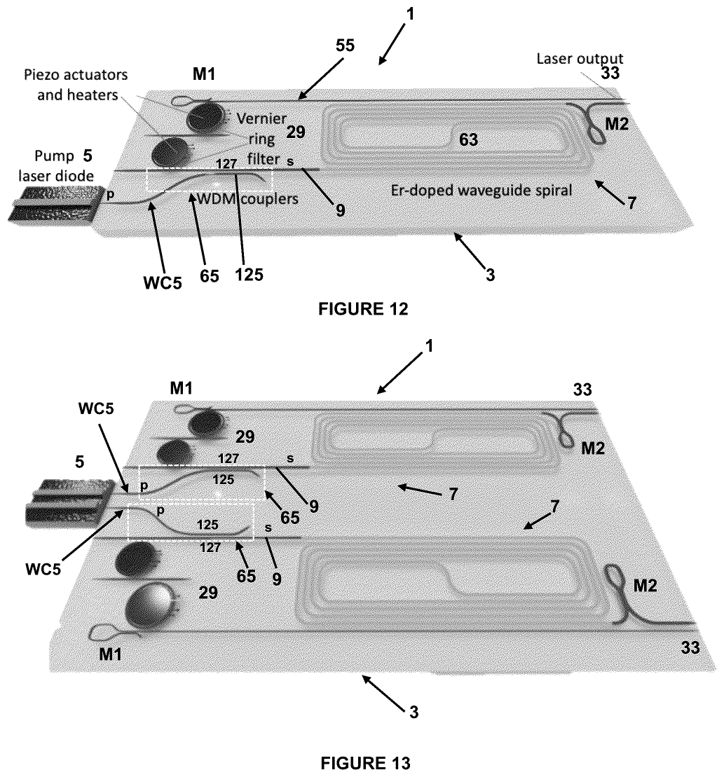

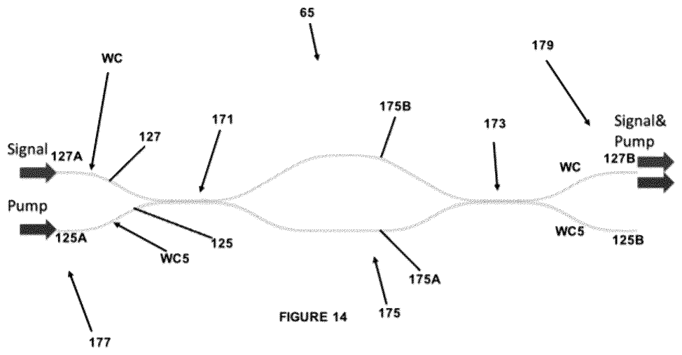

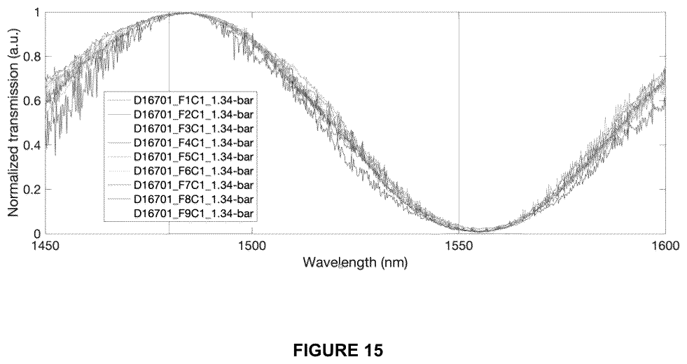

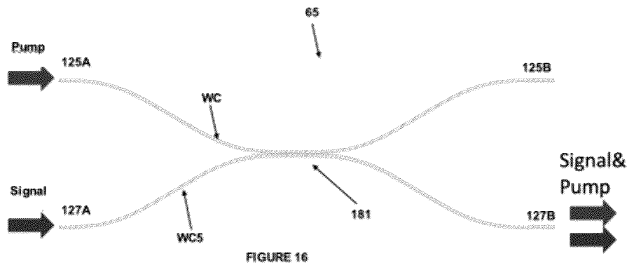

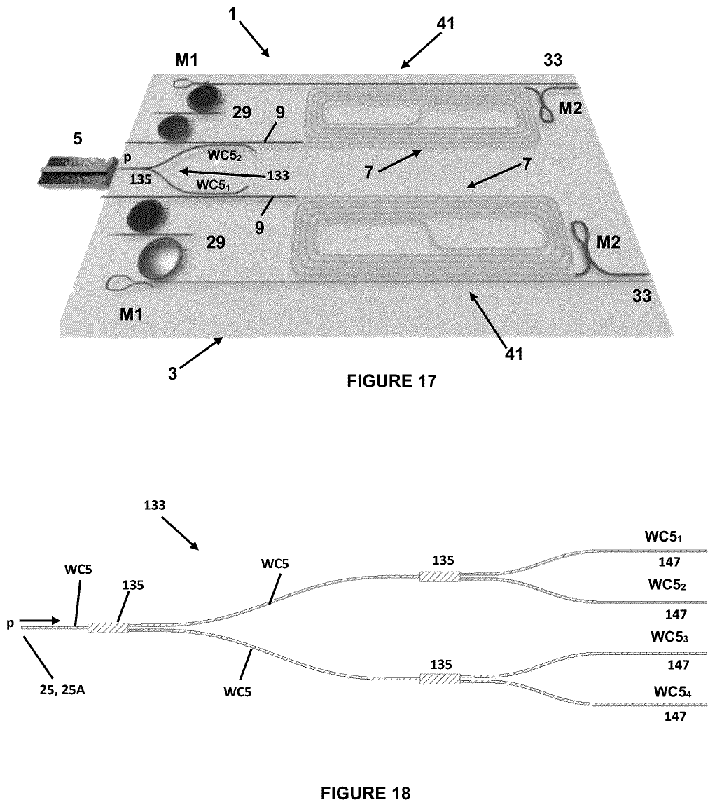

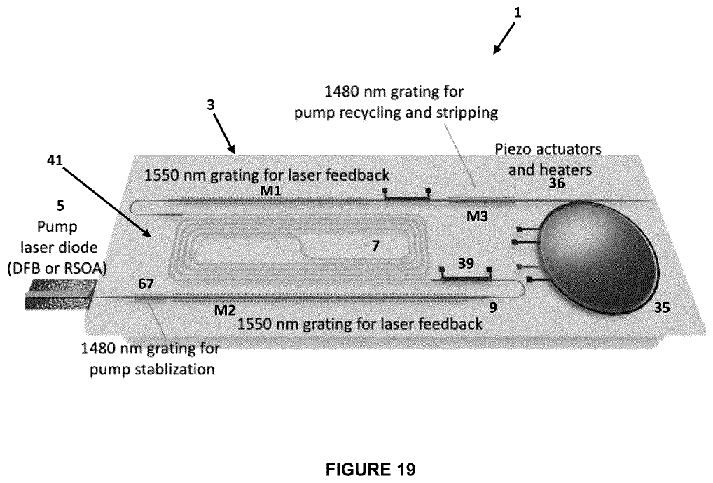

The inventors investigated the intra-cavity filtering properties by characterizing the optical transmission of the middle bus waveguide 51 (FIG. 3D). The measured transmission of the individual resonators R1, R2 used for the Vernier filter 29 is shown in FIG. 3F and the designed 2 GHz FSR was experimentally attained (98 GHz and 100 GHz, respectively), leading to a measured Vernier filter FSR of 4.65 THz that corresponds to 37.1 nm span near 1550 nm wavelength (FIGS. 3G and 3H). Such a large Vernier FSR ensures the single-wavelength lasing within the Erbium emission wavelength range (FIG. 3G). By overlapping the resonances from the two resonators R1, R2, i.e., vanishing the frequency spacing (FIG. 3H), the lasing wavelength is determined. By fitting the resonance linewidth near 194.8 THz (FIG. 31), one obtains an external coupling rate K_{ex,0}/2π=411 MHz (between the microring and the bus waveguide) and an intrinsic loss rate K₀/2π=42.5 MHz.

This strong over-coupled configuration (κₑₓ/κₒ>10) can ensure that the Vernier filter simultaneously achieves a narrow 3 dB passband bandwidth of 636 MHz and in principle a low insertion loss. Such strong overcoupling can allow for low loss operation of the Vernier filter, which however in the currently fabricated device was not attained. The Vernier filter exhibits an insertion loss of −3.2 dB due to the parasitic loss induced by the coupling from the fundamental waveguide mode to higher order modes, which leads to a suboptimal coupling ideality of I=0.87.

Furthermore, the inventors demonstrate the wavelength tunability (FIG. 4A) of the system or laser 1. The coarse tuning of laser wavelength was carried out by switching the aligned resonance of two microresonators R1, R2 (FIG. 4B). The step size of ca. 0.8 nm was determined by the micro-ring FSR. Fine tuning of the wavelength can be achieved by simultaneously shifting the two resonators R1, R2 in the same direction and adjusting the phase shifter 39 to align the corresponding cavity longitudinal mode (164 MHz spacing) to the Vernier filter passband.

FIG. 4C shows the 2-dimensional (2D) laser wavelength tuning map when varying the electrical power applied to the microheaters 37. From the recorded entire 2D map of wavelengths the settings marked in FIG. 4C were selected. This allowed for continuous and deterministic tuning over the entire wavelength band from 1548.1 nm to 1585.8 nm, maintaining power of >4 mW and SMSR of >70 dB (FIG. 4D).

Such wavelength tunability cannot be achieved in conventional rare-earth-ion-doped fiber lasers without the use of free space etalon filters. The wavelength tuning range was limited by the Vernier filter FSR and the wavelength-division multiplexing coupler transmission band. During heater power scanning, the inventors note that a few of wavelength tuning steps were missed due to the misalignment of microring resonances of the Vernier filter. During tuning, the phase shifter 39 was adjusted to maximize the output power at the desired mode. A maximum fiber-coupled output power of ca. 17 mW were measured at 1585 nm with 219 mW pump power. Other competing lasing modes apart from the predominant lasing mode were observed when using high pump power, due to the fact that the large Si₃N₄ waveguide cross section allows for multiple transversal optical modes that can coincidently satisfy the lasing condition.

To demonstrate the low noise features of the free-running EDWLs, the Inventors characterized the frequency noise, the intrinsic laser linewidth, and the relative intensity noise (RIN), respectively (FIG. 5A). Firstly, a reference external cavity diode laser (free running Toptica CTL) was tuned close to the lasing wavelength near 1560 nm of an EDWL (not packaged) with ca. 3 mW output power for heterodyne photodetection. The in-phase and quadrature components of the sampled beatnote time trace was processed trace was processed using Welch's method to obtain the single-side power spectral density (PSD) of frequency noise S_{δv}(f). The frequency noise PSD reached a plateau of h₀=62.0 Hz₂/Hz at the offset frequency of 6 MHz, corresponding to a Lorentzian linewidth of Trh₀=194.8 Hz; this measured white noise floor was masked by the ECDL's white noise floor (FIG. 5C).

The Inventors also applied the delayed self-heterodyne interferometric measurement to validate the intrinsic linewidth (FIG. 5D), which generates a power spectrum of the autocorrelation of the laser line under sub-coherence condition. In the offset frequency range from 10 KHz to 2.5 MHz where a relaxation oscillation peak was observed, the Erbium laser shows a higher frequency noise due to the laser cavity fluctuation caused by the pump laser noise transduction and the thermorefractive noise in the microresonator. The measured frequency noise at offset frequencies of <10 KHz was dominated by ECDL characteristic noise features.

The Inventors achieved a record low intrinsic linewidth of πh₀=50.1 Hz (h₀=15.9 Hz²/Hz) in an Erbium waveguide laser with a higher output power of 10 mW, when beating against a low-noise Erbium fiber laser (Koheras Adjustik). The fully packaged EDWL (FIG. 5B) with 2.8 mW output power shows a comparable intrinsic linewidth and a lower frequency noise at the mid-range offset frequencies. Using laser cavity designs with reduced cold cavity losses and increased mode area, hertz-linewidth EDWL can be feasibly achieved.

The full width at half maximum (FWHM) of the integral linewidth associated with Gaussian contribution was obtained by integrating the frequency noise PSD from the inverse of measurement time (1/T₀) up to the frequency where S_{δv}(f) intersects with the β-separation line S_{δv}(f)=8 In (2) f/Tr2 (dashed line). With the integrated surface A, the inventors obtained a minimum FWHM linewidth (8 In(2)A^{1/2}) of the free-running EDWL of 82.2 kHz at 1 ms measurement time, which does not yet supersede a fiber laser, but is lower than 166.6 kHz of an ECDL (Toptica CTL) characterized as a reference laser for comparison. For comparison, the commercial stabilized fiber-based laser shows 2.4 kHz of the FWHM linewidth at 1 ms measurement time.

The Erbium waveguide laser features a lower RIN compared to a commercial fiber laser (Koheras Adjustik KOH45). The waveguide laser shows a RIN down to −130 dBc/Hz at mid-range offset frequencies between 10 KHz and 1 MHz, lower than the fiber laser RIN that has a PSD pole induced by relaxation oscillation (FIG. 5E). The mid-range RIN was mainly limited by the pump laser RIN transduction which even contributed to an increased RIN by 5 dB for the unpackaged EDWL.

The pump RIN noise transduction at frequency above 20 MHz was suppressed due to the slow dynamics of Erbium ions. The waveguide laser RIN reduced to <−155 dBc/Hz at offset frequencies of >10 MHz. The inventors observed that the relaxation oscillation frequency of the waveguide laser varied from 0.3 MHz to 2.4 MHz when increasing the optical pump power (FIG. 5F), which is higher than the case in the fiber laser (typically <100 kHz). This higher relaxation oscillation frequency originates from the smaller saturation power and the shorter Erbium upper-state lifetime of 3.4 ms.

The Inventors compared the key performance metrics of intrinsic linewidth, wavelength tuning range, and SMSR of state-of-the-art integrated lasers based on Erbium-doped gain media and heterogenous/hybrid III-V semiconductors, with a commercial Erbium-doped fiber laser and deployed iTLA (integrated tunable laser assembly). The laser 1 of the present disclosure shows a record performance for Erbium-doped waveguide lasers, which approaches the fiber-laser coherence and enables previously unachievable wide-range wavelength tunability. The laser 1 achieves a performance on par with the state-of-the-art heterogeneous/hybrid III-V semiconductor-based lasers, and show greatly reduced fabrication complexity and cost (FIG. 6). This makes the demonstrated lasers 1 suitable for applications not only in sensing but also in optical communications. With feasible optimization of the on-chip cavity design, such as reducing the intra-cavity loss and increasing the waveguide cross sections, one can viably achieve a significant reduction of the laser linewidth, reaching Hz-level fundamental linewidth.

The photonic integrated circuit-based Erbium laser 1 of the present disclosure can advantageously assure sub-100 Hz intrinsic linewidth, low RIN noise, >72 dB SMSR, and 40 nm wide wavelength tunability with power exceeding 10 mW. The Erbium-doped waveguide lasers 1 use foundry compatible silicon nitride waveguides, and have the potential to combine fiber-laser coherence with low size, weight, power and cost of integrated photonics. Doping or co-doping with other rare-earth ions such as ytterbium (emission at 1.1 μm) and thulium (0.8 μm, 1.45 μm and 2.0 μm) allows access to other wavelengths.

FIG. 7 shows a graphic design system GDSII layout of the integrated EDWLs, and shows a part of the photonic chip 3 layout that comprises or consists of three EDWLs with different Erbium-doped gain spiral lengths of 17 cm, 23 cm, and 31 cm. FIG. 7 illustrates the circuit design layout 3 of a Vernier based laser located in the third device row of FIG. 3A. Each EDWL device exhibits a compact footprint of only 2×3 mm². The laser device is structured as a linear optical cavity 11 with a spiral Erbium-doped gain waveguide 7, a microresonator-based Vernier filter 29, and two partial reflectors M1, M2 formed by loop mirrors at both ends. The length of the spiral waveguides 7 implanted with Erbium ions was varied from 17 cm to 31 cm for exemplary testing purposes. The radii of two micro-ring resonators R1, R2 of the Vernier filter 29 are 228.5 μm and 233.5 μm, respectively in this exemplary embodiment, to provide FSRs near 100 GHz but with a 2 GHz difference. The Loop mirror 1 (M1) is designed as a Sagnac loop composed of a broadband directional coupler, aiming to provide broadband laser light reflection. Loop mirror 2 (M2) is based on a Sagnac loop consisting of a longer, dichroic direction coupler, providing reflection near 1550 nm and transmission near 1480 nm or 980 nm (pump wavelength).

To allow efficient coupling of optical pump into the gain waveguide, an exemplary wavelength selective Sagnac reflector was designed with high transmittance at a pump wavelength (1480 nm) and high reflectance at lasing wavelengths. This reflector is constructed with a waveguide directional coupler with coupling ratio engineered to be 0:100 and 50:50 for 1480 nm and 1550 nm, respectively.

Therefore, the output port of Loop mirror 2 (M2) can be simultaneously used for optical pump injection and laser light extraction (Pump input port 2 or Laser output port 2). The optical pump can also be injected through the port connected to the bus waveguide of the Vernier filter (Pump input port 1).

Multimode Si₃N₄ waveguides were used to construct the Erbium-doped waveguide laser 1 in order to reduce the scattering loss at waveguide sidewalls. Together with the two polarizations of the optical field, the laser 1 can exhibit a few mode families with different vernier offsets but similar tuning behavior (see FIG. 9). The Inventors performed wide-range two-dimensional scanning of the heater power to heaters 37 to investigate the laser wavelength tuning. For each point in FIG. 4C, one of the heater powers was kept fixed and rapidly swept the other over a small range to find the optimal operation point with maximum laser power. As the lasing wavelength in each mode family has nearly linear relation with the heating power, when visualizing the wavelength tuning map in a three-dimension plot (heater powers and wavelength), each of the mode families can form an individual parallel plane. It is noted that those planes can be folded back to another when the wavelength was tuned out from the gain bandwidth, due to the presence of the Vernier filter FSR. Some weak ‘persistent’ modes (horizontal planes in FIG. 9) that were independent of the heater power were observed when the vernier filters were misaligned. Such modes were most likely caused by the chip facet reflection.

In FIG. 4C, the Inventors selected the two planes that exhibit the highest output power. It is believed that those modes correspond to the fundamental transverse electric mode which have the least propagation loss in the waveguides. For clarity in the tuning map, the inventors selected only one family of modes that show the best performance (FIG. 4C). It was noted that access to shorter lasing wavelengths (i.e., <1550 nm) was compounded by the spectral response of the wavelength division multiplexing (WDM) coupler located at one end of the laser cavity. The transmission band of the WDM coupler near 1550 nm drifts towards the longer wavelength due to fabrication imperfection. This can be mitigated using tunable coupler design and improved fabrication dimension control.

While the invention has been disclosed with reference to certain preferred embodiments, numerous modifications, alterations, and changes to the described embodiments, and equivalents thereof, are possible without departing from the sphere and scope of the invention. Accordingly, it is intended that the invention not be limited to the described embodiments and be given the broadest reasonable interpretation in accordance with the language of the appended claims. The features of any one of the above described embodiments may be included in any other embodiment described herein.

1. A hybrid integrated photonic integrated circuit laser comprising:
at least one photonic integrated circuit including at least one elongated optical waveguide comprising at least one elongated gain medium waveguide, at least one first optical reflector and at least one second optical reflector, the at least one gain medium waveguide being located or extending between the first and second optical reflectors and being located inside an optical cavity formed between the at least one first and second optical reflectors to provide optical feedback to the at least one gain medium waveguide;
at least one pump laser diode to provide electromagnetic radiation to the gain medium waveguide;
wherein the at least one elongated optical waveguide, the at least one first optical reflector and the at least one second optical reflector are monolithically integrated inside the at least one photonic integrated circuit, wherein the at least one gain medium waveguide comprises a rare-earth ion implanted silicon nitride waveguide core, and wherein the least one pump laser diode is positioned adjacent to the at least one photonic integrated circuit and is coupled to a lateral facet or is coupled to a top facet of the at least one photonic integrated circuit to provide pump radiation to the at least one rare-earth ion implanted silicon nitride waveguide core to generate lasing operation by at least one laser optical gain device of the at least one photonic integrated circuit, the at least one laser optical gain device including the at least one elongated optical waveguide, the at least one first and second optical reflectors and the at least one elongated gain medium waveguide.

2. The hybrid integrated photonic integrated circuit laser according to claim 1, wherein the at least one elongated optical waveguide, the first optical reflector and the second optical reflector extend coplanar across the at least one photonic integrated circuit.

3. The hybrid integrated photonic integrated circuit laser according to claim 1, wherein the at least one elongated optical waveguide, the first optical reflector and the second optical reflector each comprise an elongated silicon nitride waveguide core.

4. The hybrid integrated photonic integrated circuit laser according to claim 3, wherein the elongated silicon nitride waveguide core of the at least one elongated optical waveguide is optically coupled to the elongated silicon nitride waveguide core of the first and/or second optical reflectors.

5. The hybrid integrated photonic integrated circuit laser according to claim 4, wherein the at least one elongated optical waveguide, the first optical reflector and the second optical reflector each comprise the elongated silicon nitride waveguide core continuously extending through the first optical reflector, through the at least one elongated optical waveguide and through the second mirror; the elongated silicon nitride waveguide core extending between the first optical reflector and the at least one elongated optical waveguide and between the at least one elongated optical waveguide and the second mirror.

6. The hybrid integrated photonic integrated circuit laser according to claim 1, wherein the at least one photonic integrated circuit includes at least one optical device configured to set a single-mode lasing operation of the hybrid integrated photonic integrated circuit laser and tune a single-mode lasing wavelength of the hybrid integrated photonic integrated circuit laser.

7. The hybrid integrated photonic integrated circuit laser according to claim 1, wherein the at least one photonic integrated circuit includes at least one tuner or tuning device configured to determine and tune a lasing wavelength of the hybrid integrated photonic integrated circuit laser.

8. The hybrid integrated photonic integrated circuit laser according to claim 1, wherein the at least one photonic integrated circuit comprises at least one intra-cavity optical filter located between the first mirror and the second mirror, the at least one intra-cavity optical filter being in optical communication with the at least one elongated optical waveguide and the first or second mirror, the at least one intra-cavity optical filter being configured to provide or output a transmission signal at a wavelength aligned with a longitudinal mode wavelength of the optical cavity, and within an erbium ion emission wavelength range, to select a lasing longitudinal mode to permit single-mode lasing operation;

9. The hybrid integrated photonic integrated circuit laser according to claim 8, wherein the at least one intra-cavity optical filter is further configured to remove erbium ion spontaneous emission at wavelengths outside the lasing longitudinal mode wavelength.

10. The hybrid integrated photonic integrated circuit laser according to claim 8, wherein the at least one intra-cavity optical filter comprises or consists of a Vernier filter including a first resonator and a second resonator, the first and second resonators being optically coupled to each other, and wherein the first resonator is optically coupled to the first mirror and the second resonator is optically coupled to the at least one elongated optical waveguide, and wherein the first resonator and the second resonator are arranged to form cascaded add-drop resonators to define a Vernier free spectral range permitting single-mode lasing operation.

11. The hybrid integrated photonic integrated circuit laser according to claim 10, wherein the at least one photonic integrated circuit further comprises at least one intra-cavity optical filter tuner configured to change a wavelength of the transmission signal provided by the at least one intra-cavity optical filter.

12. The hybrid integrated photonic integrated circuit laser according to claim 11, wherein the at least one intra-cavity optical filter tuner is configured to act on the first resonator and/or the second resonator to change a resonance wavelength of the first resonator and/or the second resonator to overlap the resonance wavelengths of the first and second resonators and determine a lasing wavelength.

13. The hybrid integrated photonic integrated circuit laser according to claim 11, wherein the at least one intra-cavity optical filter tuner comprises a heater and/or a piezoelectric actuator.

14. The hybrid integrated photonic integrated circuit laser according to claim 1, wherein the at least one photonic integrated circuit further comprises at least one phase shifter located between the first and second mirrors and arranged to act on the at least one elongated optical waveguide to displace a cavity longitudinal mode of the optical cavity.

15. The hybrid integrated photonic integrated circuit laser according to claim 1, wherein the first mirror and/or the second mirror comprise a loop mirror or a waveguide Bragg grating.

16. The hybrid integrated photonic integrated circuit laser according to claim 1, wherein the photonic integrated circuit includes a residual pump light removal device configured to reduce or eliminate residual pump light from the laser output light that is outputted by the at least one laser optical gain device of the photonic integrated circuit.

17. The hybrid integrated photonic integrated circuit laser according to claim 1, wherein the at least one pump laser is configured to simultaneously emit a plurality of pump wavelengths and to simultaneously pump the at least one laser optical gain device simultaneously with plurality of spectrally separated pump wavelengths.

18. The hybrid integrated photonic integrated circuit laser according to claim 1, wherein the least one elongated waveguide includes at least one mode stripper device configured to remove transversal optical modes from the elongated waveguide allow a single transversal mode to propagate in the elongated waveguide.

19. The hybrid integrated photonic integrated circuit laser according to claim 1, wherein the at least one photonic integrated circuit includes at least one integrated pump light splitter configured to split pump light and distribute the split pump light to separately pump the at least one or a plurality of laser optical gain devices on the photonic integrated circuit.

20. The hybrid integrated photonic integrated circuit laser according to claim 1, wherein the at least one photonic integrated circuit includes at least one on-chip integrated optical coupler, wherein the on-chip integrated optical coupler is configured to communicate or couple optical pump light from the at least one at least one pump laser diode to the at least one elongated waveguide of the at least one laser optical gain device.

21. The hybrid integrated photonic integrated circuit laser according to claim 1, wherein at least one photonic integrated circuit includes at least one integrated wavelength-division multiplexing coupler, and the integrated wavelength-division multiplexing coupler is configured to combine or unify (i) optical pump light provided by the at least one pump laser diode and (ii) the lasing light signal of the at least one laser optical gain device into an embedded planar waveguide core of at least one elongated optical waveguide, the optical pump light and the lasing light signal having different wavelengths.

22. The hybrid integrated photonic integrated circuit laser according to claim 1, wherein the photonic integrated circuit includes an on-chip Bragg grating having a reflection centered at a pump wavelength of the at least one pump laser diode and configured to provide feedback to the at least one pump laser diode to stabilize a pump wavelength emission value of the at least one pump laser 5 against temperature variation.
